(19) United States
(12) Patent Application Publication
(10) Pub. No.: US 2019/0258061 A1
(43) Pub. Date: Aug. 22, 2019

(54) Integrated Augmented Virtual Reality System

(71) Applicant: Dennis Solomon, Yarmouth Port, MA (US)

(72) Inventor: Dennis Solomon, Yarmouth Port, MA (US)

(21) Appl. No.: 16/190,044

(22) Filed: Nov. 13, 2018

Related U.S. Application Data
(63) Continuation-in-part of application No. 14/189,232, filed on Feb. 25, 2014.
Application No. 14/189,232 is a continuation-in-part of application No. 13/294,011, filed on Nov. 10, 2011.
(60) Provisional application No. 62/585,071, filed on Nov. 13, 2017.
(60) Provisional application No. 62/632,469, filed on Feb. 20, 2018.

(51) Int. Cl. G02B 27/01; G06F 1/16

(52) U.S. Cl. CPC G02B 27/0172; G02B 27/0176; G02B 2027/0178; G02B 2027/0138; G06F 1/163

(57) ABSTRACT

An integrated entertainment system is presented having a novel, ergonomic, lightweight augmented/virtual headset and novel activation accessories, together with a novel image/data projector which enables new levels of entertainment. The novel headset includes complementary, catadioptric optics and a foldable, transformable design and construction. The integrated accessories include a low-cost construction of identifiable, augmented reality target. The integrated data/image project includes a lightweight, compact construction enabling continuous, two-axis, 360-degree rotation without electrical transfer by slip rings or other means.

Another object of the present invention is an improved method and device to compactly wear upon one's person and transform into an immersive, augmented or virtual environment including a coordinated event manifestation and audience effects.

Another object of present invention relates generally to robotic, moving-light devices including those which illuminate and project data and images in visible and invisible wavelengths particularly to those used for theatre, stage, events, security and defense.

One object of the present invention is an improved luminaire, compact in size, lightweight, ad with a low moment of inertia.

Another object is 4π, continuous scan of the venue,

Another object is high efficiency, low cost, low maintenance design without electrical slip rings, split transformers or other devices to transfer base electrical power to a rotating optical element.

Another object is low moment of inertia of the rotating optical projection element,

Another object is lightweight and compact design,

### BRIEF DESCRIPTION OF THE DRAWINGS

The above and still further objects, features and advantages of the present invention will become apparent upon consideration of the following detailed disclosure of specific embodiments of the invention, especially when taken in conjunction with the accompanying drawings, wherein:

FIG. 1 present the ergonomic, head mounted embodiment of the present invention.

FIG. 2 presents the display element above the visor embodiment.

FIG. 3 presents the angled display element embodiment.

FIG. 4 presents an external variable shutter embodiment.

FIG. 5 presents an embedded user sensor embodiment.

FIG. 6 presents a curved first reflector embodiment.

FIG. 7 presents an external camera embodiment.

FIG. 8 present a total internal reflection, waveguide embodiment.

FIG. 9 presents a microarray embodiment.

FIG. 10 present a discontinuous first reflector embodiment.

FIG. 11 presents an eye sensor array with illumination.

FIG. 12 presents a transmissive lens-display array embodiment.

FIG. 13 present a diffusive surface-to-distant screen embodiment.

FIG. 14 presents a TIR reversible display embodiment.

FIG. 15 presents a reflective-diffuse embodiment in reflective mode.

FIG. 16 presents a reflective diffuse embodiment in transparent mode.

FIG. 17 presents a flip-around embodiment.

FIG. 18 presents a Watch to HeadSet transformable embodiment.

FIG. 19 shows a flip-around embodiment.

FIG. 20 shows a TIR composite lens embodiment.

FIG. 21 shows another TIR composite lens embodiment.

FIG. 22 shows mixed reality headset embodiment.

FIG. 23 show ‘barn door’ light blocks for mixed reality headset embodiments.

FIG. 24 show planar, one dimensional and two dimensional first reflector embodiments.

FIG. 25 show monoscopic-stereoscopic reflector embodiments.

FIG. 26 show further monoscopic-stereoscopic reflector embodiments.

FIG. 27 shows a holographic beam director embodiment.

FIG. 28 shows FIG. 27 with the virtual position of second reflector shown.

FIG. 29 shows a focal distance adjustment embodiment.

FIG. 30 shows a beam-direction focal distance adjustment embodiment.

FIG. 31 shows a top view of an autostereoscopic embodiment.

FIG. 32 shows a side view of FIG. 31

FIG. 33 shows another partial reflector embodiment.

FIG. 34 shows a foldable embodiment.

FIG. 35 show another foldable embodiment.

FIG. 36 shows a hat-attachable embodiment.

FIG. 37 shows a polarized window, stereoscopic embodiment.

FIG. 38 shows a scanning projection embodiment.

FIG. 39 shows a scanning embodiment of FIG. 38

FIG. 40 shows another watch-headset embodiment.

FIG. 41 show a foldable panel watch-headset embodiment.

FIG. 42 show an external camera, watch-headset embodiment.

FIG. 43 show a stereoscopic, polarization, watch-headset embodiment.

FIG. 44 show the distinction between full lens verses matrix optics.

FIG. 45 show another transparent-diffusive, watch-headset embodiment.

FIG. 46 show the distinction between clear and active matrix regions.

FIG. 47 show a transformable wrist to eyeglass arms.

FIG. 48 show a ‘cardboard’ folding headset embodiment.

FIG. 49 show side views of a ‘cardboard’ embodiment.

FIG. 50 shows the cushioned ‘cardboard’ embodiment.

FIG. 51 shows an expandable case embodiment.

FIG. 52 shows an expandable case with slide embodiment.

FIG. 53 shows a transformable ‘cardboard’ embodiment.

FIG. 54 show side views of a transformable display embodiment.

FIG. 55 shows a multiple orientation embodiment.

FIG. 56 shows a transformable, case embodiment.

FIG. 57 shows chromatic overlay, activation screen embodiment.

FIG. 58 shows a touchpad embodiment.

FIG. 59 shows a zoom optic embodiment.

FIG. 60 shows a lateral variable zoom optic embodiment.

FIG. 61 shows another collapsible embodiment.

FIG. 62 shows a variable density embodiment.

FIG. 63 shows a side and top view of a cushioned embodiment.

FIG. 64 shows a photochromic embodiment.

FIG. 65 shows a first reflective mirror embodiment.

FIG. 66 show an actable button embodiment.

FIG. 67 shows a reduced optics system embodiment.

FIG. 68 shows a side view of FIG. 67

FIG. 69 show folded application embodiments.

FIG. 70 shows another folded application embodiment.

FIG. 71 shows an optic path centering embodiment.

FIG. 72 shows a top view of FIG. 71.

FIG. 73 shows Application use definitions.

FIG. 74 shows Application modes.

FIG. 75 shows application of present invention in an audience.

FIG. 76 show a variable, image recognition embodiment.

FIG. 77 shows a rotational, image recognition embodiment.

FIG. 78 shows a trigger activated, image recognition embodiment.

FIG. 79 shows a composite, image recognition wand embodiment.

FIG. 80 shows a beam directional projector embodiment.

FIG. 81 shows a closeup of a beam directional projector embodiment.

FIG. 82 shows another beam directional projector embodiment.

FIG. 83 shows a full-enclosed beam directional projector embodiment.

FIG. 84 shows another beam directional projector embodiment.

FIG. 85 shows a track-controlled, beam directional projector embodiment.

FIG. 86 shows another beam directional projector embodiment.

FIG. 87 shows another beam directional projector embodiment.

FIG. 88 shows a foldable projection embodiment.

FIG. 89 shows a transparent window beam direction projector embodiment.

FIG. 90 shows a foldable projection embodiment.

FIG. 91 shows a foldable projection embodiment.

FIG. 92 shows a foldable projection embodiment.

FIG. 93 shows a slidable headset embodiment.

FIG. 94 shows a wearable, base station for the watch-headset embodiment.

FIG. 95 shows another foldable headset embodiment.

FIG. 96 shows an air channel headband, headset embodiment.

FIG. 97 shows an insert conformed first reflector headset embodiment.

### DETAILED DESCRIPTION OF THE INVENTION

Ergonomic Series

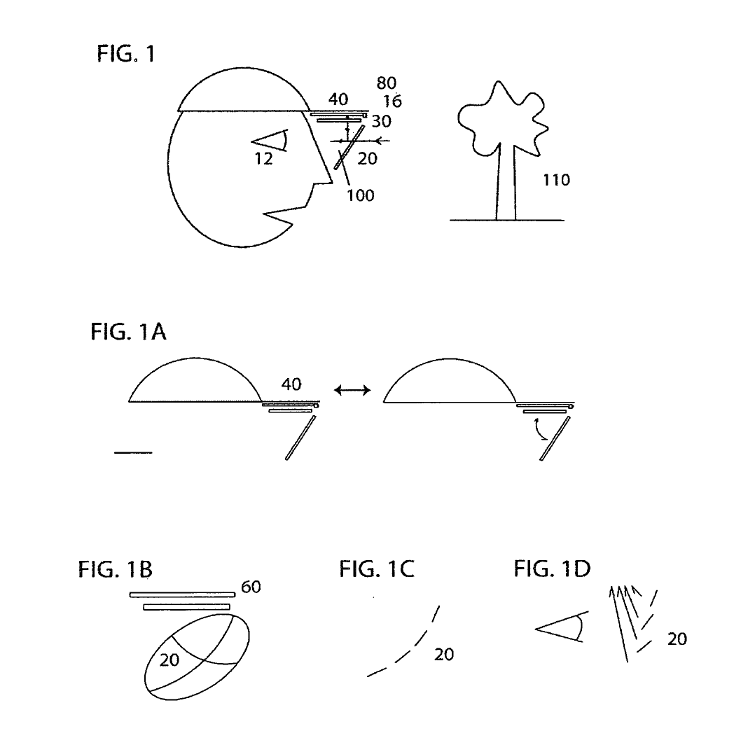

FIG. 1 shows a side view of the collapsible, ergonomic, forehead-mounted embodiment of the present invention where the user 10 augments his view of the external environment 110 with an overlaid image of a first display 40 projected along a merged principal optical path 100 by means of optical components which may include a first partial-reflective optical element or visor 20 and a first transmissive lens 30.

The first partially reflective surface 20 may be continuous or discontinuous, static or dynamic, comprised of one or more elements and be of any shape, material or construction. In a representative embodiment, said reflective surface 20 is a partially-reflective, first surface mirror 20 oriented at an angle such that the reflected principal optical path is directed towards said first display 40.

Said reflective surface may of any shape, including but not limited to planar or curved. In a curved embodiment, said reflective surface may contribute a specific optical transformation which may be correlated with the first lens assembly 30 to present the designed image from the first display 40 to the user's eye 12. FIG. 6 shows a representative embodiment, having a concave and thus convergent effect on the optical path at the optic plane of the first lens or display.

FIG. 1A presents a side view of the collapsible embodiment of the present invention where principal elements—the first optic reflector 20, the first lens 30 and display 40 are collapsible into a small package.

Brim Mounted Series

FIG. 1 further shows a side view of the collapsible, brim-mounted embodiment of the present invention where the user 10 augments his view of the external environment 110 with an overlaid image of a first display 40 projected along a merged principal optical path 100 by means of optical components which may include a first partial-reflective optical element or visor 20 and a first transmissive lens 30.

The first partially reflective surface 20 may be continuous or discontinuous, static or dynamic, comprised of one or more elements and be of any shape, material or construction. In a representative embodiment, said reflective surface 20 is a partially-reflective, first surface mirror 20 oriented at an angle such that the reflected principal optical path is directed towards said first display 40.

Said reflective surface may of any shape, including but not limited to planar or curved. In a curved embodiment, said reflective surface may contribute a specific optical transformation which may be correlated with the first lens assembly 30 to present the designed image from the first display 40 to the user's eye 12. FIG. 6 shows a representative embodiment, having a concave and thus convergent effect on the optical path at the optic plane of the first lens or display.

FIG. 1A presents a side view of the collapsible embodiment of the present invention where principal elements—the first optic reflector 20, the first lens 30 and display 40 are collapsible into a small package.

FIG. 1b presents a 1 and 2 axis curved reflector 20.

FIG. 1c presents a discontinuous first reflector.

FIG. 1d present another embodiment of a discontinuous first reflector in a manner of a reflectively coated Fresnel surface.

Additional articulated, foldable side panels 16′ of the visor may be provided, with optional attachments to the see-through optic 20 or other elements.

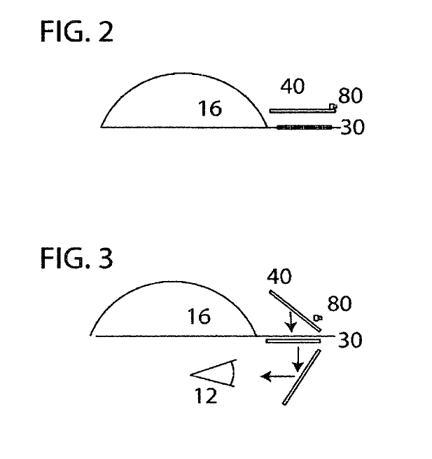

FIG. 2 presents a side view of a representative embodiment having the display 40 above the visor 16 and the first lens 30 in the plane of the visor 16. One or more external cameras 80 may be mounted in the region.

FIG. 3 presents a side view of a representative embodiment which the display 40 is mounted at an angle to the plane of the visor 16.

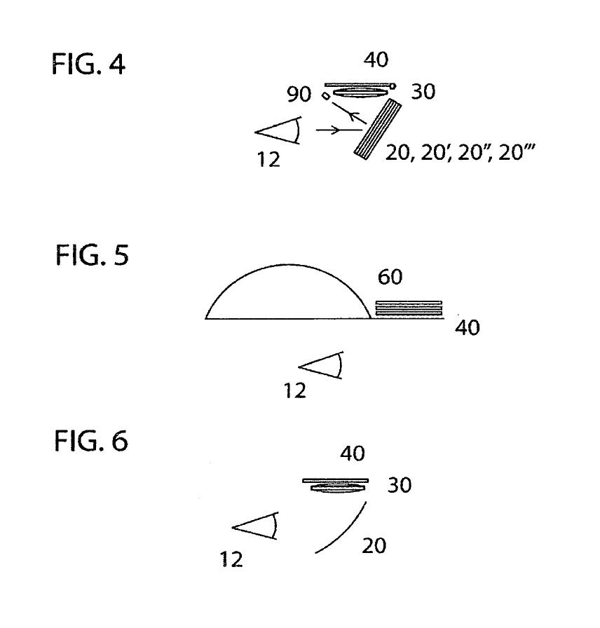

FIG. 4 presents a side view of a representative embodiment having an external variable shutter element 28 to control the brightness of the external view. Said shutter element 28 may be divided into individually-controlled pixels. Interior to the shutter element 28 may be a secondary partial reflector 26 having the properties to direct one or a group of wavelengths of optical radiation from a secondary source or towards a secondary sensor/camera. One embodiment may comprise an IR emitter and camera to track the user's eyes.

FIG. 5 presents a side view of an embodiment having sensors (eye tracking 90, physiology 66, etrc) embedded in the display 40.

FIG. 6 presents a side view of a curved first reflector 20.

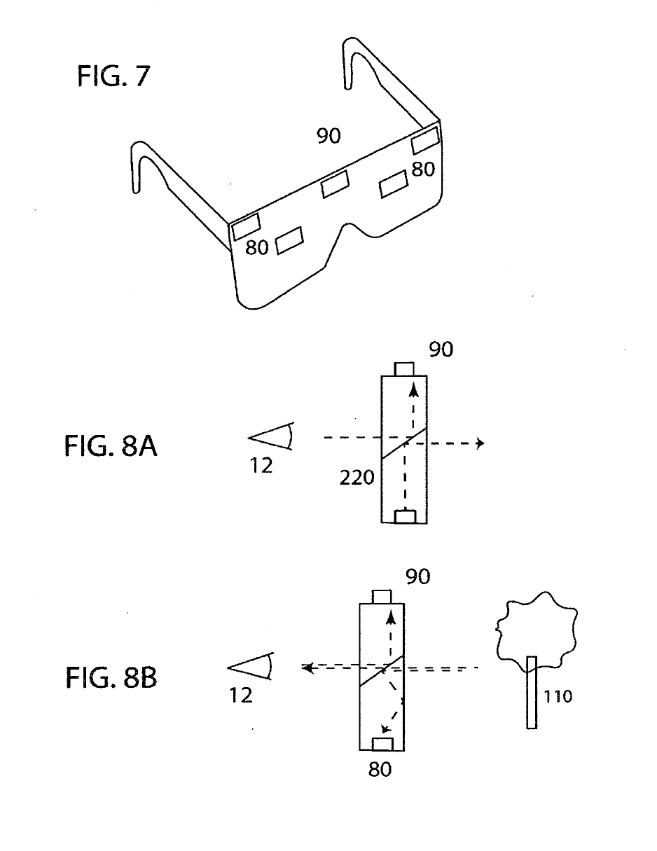

FIG. 7 presents a perspective view of an embodiment having external cameras 80′, 80″ embedded in the field of view. A external projector 84 may be mounted on the assembly 14 which may project an non-visible (IR, UV) pattern enabling hand gesture recognition and/or a visible pattern further enabling user interaction with and reference to the external environment.

FIG. 8A present a side view of a waveguide embodiment where the eye sensor/camera 90 is positioned in the optical path of the waveguide 220 such the user's eye 12 is imaged by means of internal reflection; the external environment is imaged in the external camera 80 by means of internal reflection; and the external environment is visible to the user's eye. Said internal reflection may include but is not limited to total internal waveguide reflection, an embedded partial reflective optic or a dynamic optically-active region.

FIG. 8B present a side view of a total internal waveguide embodiment where the eye sensor/camera 90 is positioned in the optical path of the waveguide 220 such the user's eye 12 is imaged by means of internal reflection; the external environment is imaged in the external camera 80 by means of internal reflection; and the external environment is visible to the user's eye. Said internal reflection may include but is not limited to total internal waveguide reflection, TIR employing polarized illumination, TIR employing a Brewster's angle junction, an embedded partial reflective optic or a dynamic optically-active region.

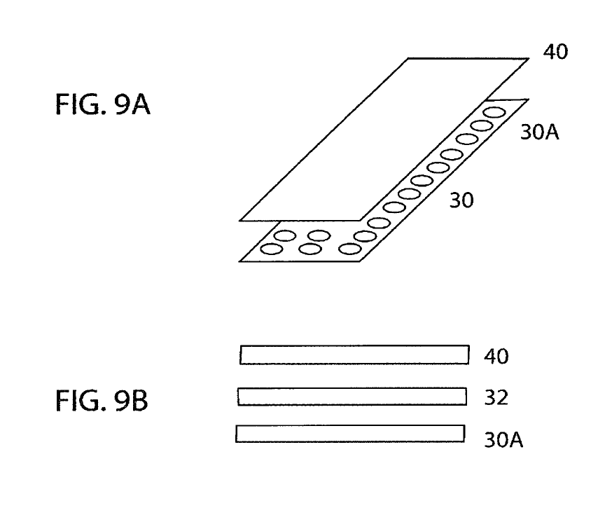

FIG. 9 presents a perspective view of an embodiment having a micro-array 30A first lens 30 positioned proximal to the display 40.

FIG. 9a present a side view of the display/first lens embodiment having a dynamic optical path displacement component 32 positioned between the micro-array first lens 30A and the display. Said displacement component 32 may be mechanical, electronic or optical including but not limited to a resonant micro-prism array; liquid crystal prisms assembly; or an optically-activated, variable refractive index optical element.

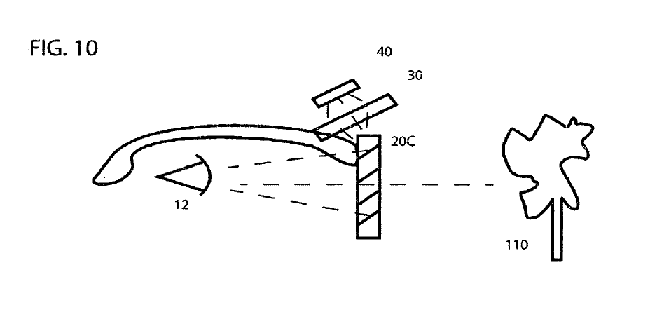

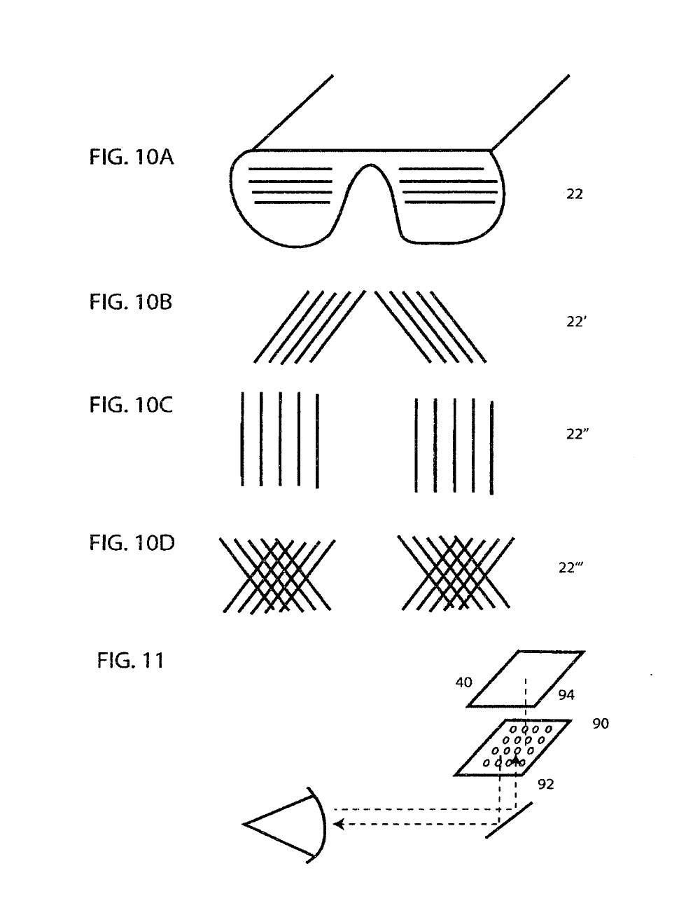

FIG. 10 presents a side view of a discontinuous first reflector surface 20c having elements with a different principal optic orientation. In the representative embodiment shown, the element are XXXXX

discontinuous reflective elements 20c may be partially, variably or fully reflective, enabling the transmission of the external environment 110 between the discontinuous reflective elements 20c.

FIG. 10a-d presents front representative views of four patterned embodiments of the assembly 200 which may include one or more of the elements including but not limited to the reflector 20, the first lens 30 and the display 40. These may include but are not limited to horizontal, oblique, vertical, intersecting and any other pattern.

FIG. 11 presents a perspective representative view of eye sensor array 90 integrating a camera sensor element 92 and an illumination element 94.

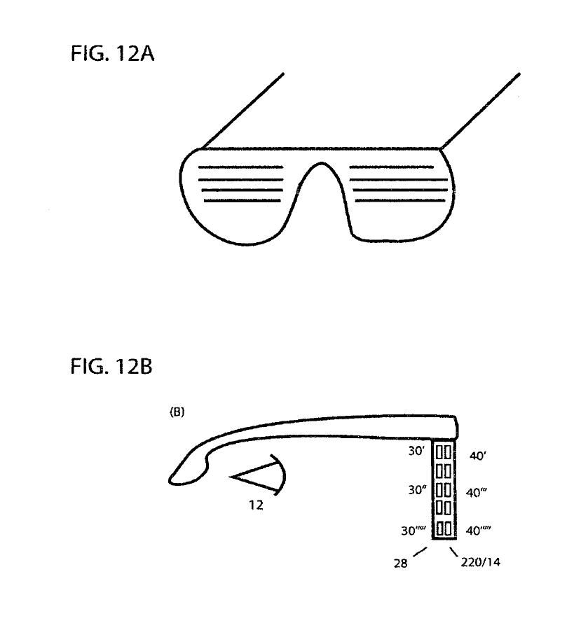

FIG. 12 presents a side view of an alternative embodiment comprised of an array of first lens element 30′—and associated display elements 40′ with clear transmissive space in between enabling the transmission of the external environments 110. As with all of the embodiments described herein, a variable occlusion transmissive filter 28 may be provided to variably occlude some or all of the external environment 110.

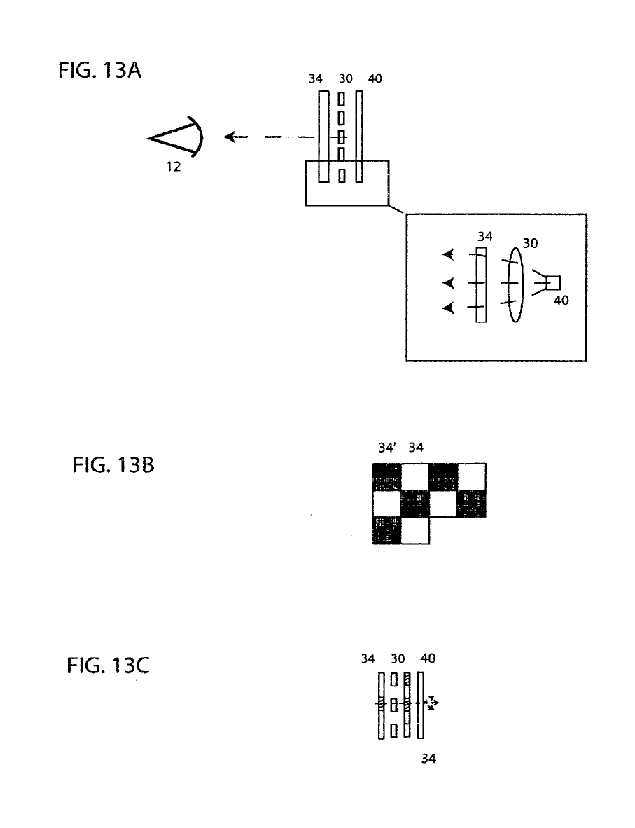

FIG. 13 presents a side view of compact, transparent-diffusive display embodiment where a variable, transparent to diffusive optic 34 is positioned proximal to the first display means 40 such that the image pixel of the display 40 set to a focal distance from the user 12 commonly ten (10) feet for HMDs shown in insert x13a, is transformed into a surface screen display with pixel dimensions approximating 34′ that of the output of individual display pixel 40′ through the first lens means 30′. In a representative example, the OLED pixel dimensions 40′ may be 5 microns, the output through first lens means 30′ may be 20 microns, and thus an HD resolution (1920) screen would be approximately 40 millimeters. The first lens means 30′ may incorporate dynamic, global or individual pixel focal length control, or by static.

The transparent-diffusive layer may be integrated with the first lens means 30 employing liquid crystal, chromographic, holographic, acoustic, c-ink (movable microelements), dynamic nanostructures, micromirrors (DMD) or other technologies. This may be electronically, photonically, acoustically, thermally, mechanically or activated by other means.

In FIG. 13b, an embodiment is shown having a microarray of transparent-diffusive elements 34′D, 34′T may be micromechanically aligned according to the desired state. All of the components including the display pixel 40′ may have a transparent, neutral state enabling undistorted transmissive viewing through the composite lens 15; or may be spaced with adjacent transparent neutral regions enabling the transmissive viewing.

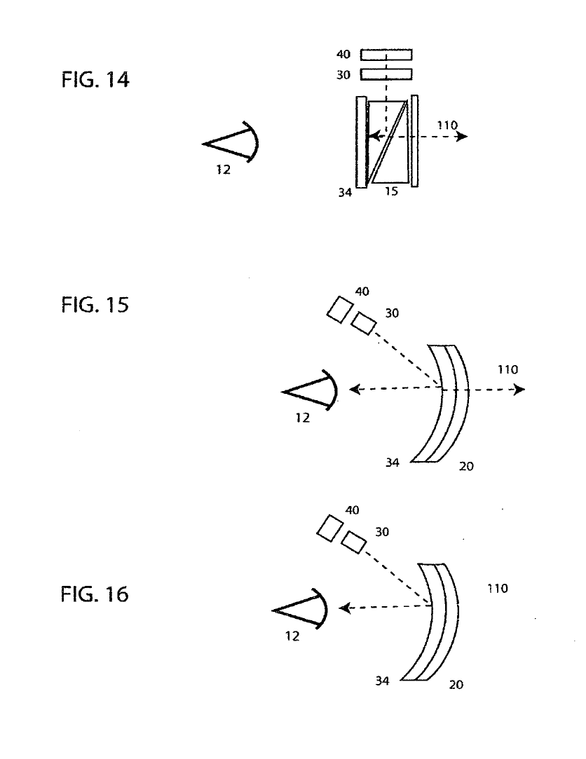

FIG. 14 shows a TIR composite lens 15 having a transparent-reflective diffuse optic layer 34 which enables the visibility of the display 40 to the external environment 110. The first lens means 30 may adjust the display focal length accordingly (focusing the image of the display on the reflective diffusive layer 34 rather than the virtual object distance external of the headgear for virtual/augmented reality.

FIG. 15 shows a visor-type embodiment having a transparent-reflective diffuse optic layer 34 which enables the visibility of the display 40 to the external environment 110. The first lens means 30 may adjust the display focal length accordingly (focusing the image of the display on the reflective diffusive layer 34 rather than the virtual object distance external of the headgear for virtual/augmented reality.

FIG. 16 shows the reflective-transparent mode of FIG. 15.

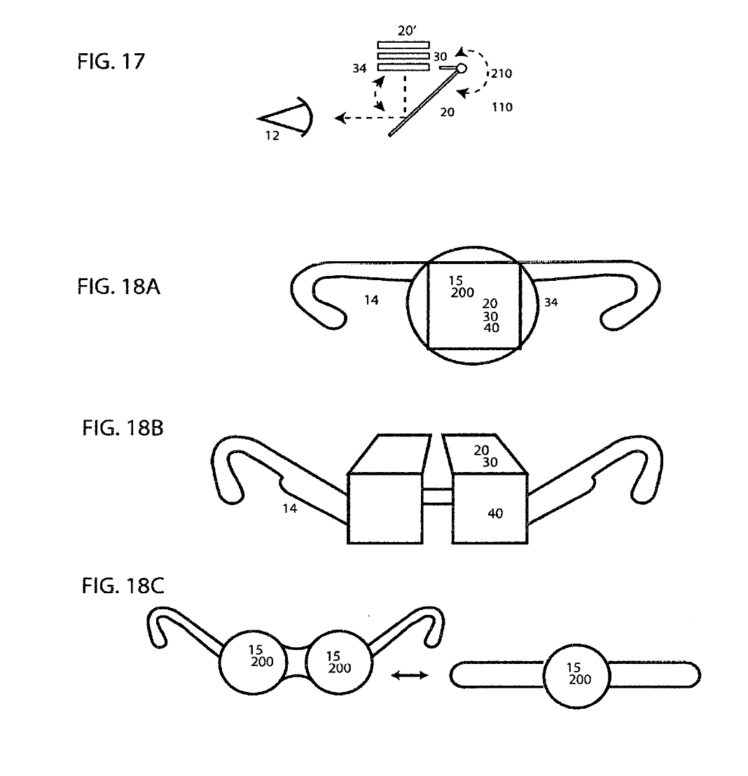

FIG. 17 shows a flip-around embodiment wherein the partial-reflective surface means 20 pivots, swivels or may be moved to the back position 20′ in the ‘watch’ mode. The transparent-diffusive layer 34 would then become the ‘watch’ display image.

FIG. 18c shows the transformation of an FIG. 18A Watch to FIG. 18B Headset wherein the composite unit 15/200 may be modular and fits in a headgear/wristband structure 14.

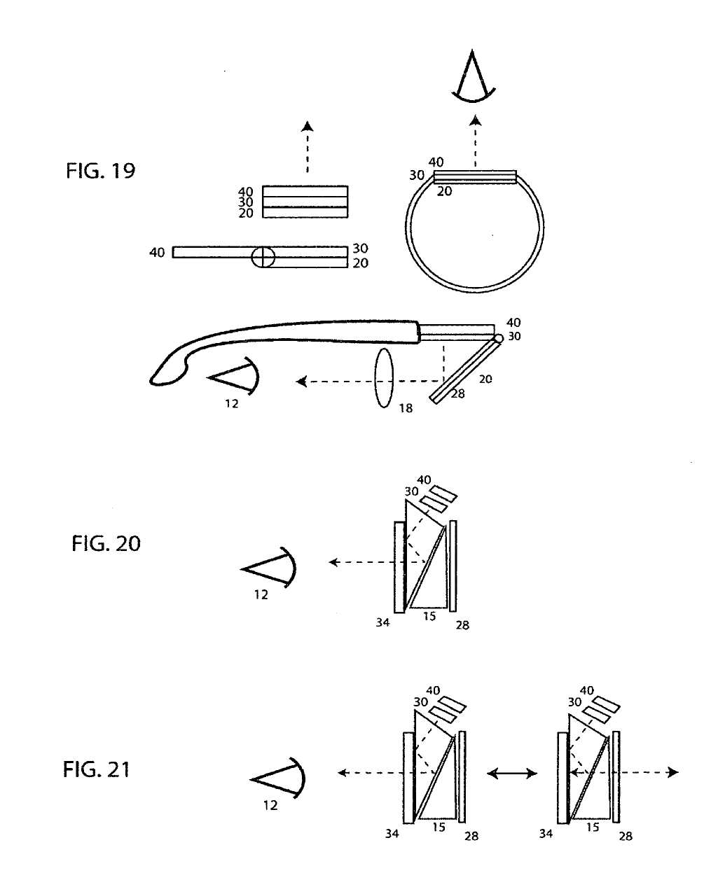

FIG. 19 shows a flip-around embodiment wherein the partial-reflective surface means 20 pivots, swivels or may be moved to the back position 20′ in the ‘watch’ mode. The transparent-diffusive layer 34 would then become the ‘watch’ display image.

FIG. 20 shows a TIR composite lens 15 having a transparent-reflective diffuse optic layer 34 which enables the visibility of the display 40 to the external environment 110. The first lens means 30 may adjust the display focal length accordingly (focusing the image of the display on the reflective diffusive layer 34 rather than the virtual object distance external of the headgear for virtual/augmented reality. An external shutter 20 is shown.

FIG. 21 shows a TIR composite lens 15 having a transparent-reflective diffuse optic layer 34 (reflective) which enables the visibility of the display 40 to the external environment 110. The first lens means 30 may adjust the display focal length accordingly (focusing the image of the display on the reflective diffusive layer 34/28 layer rather than the virtual object distance external of the headgear for virtual/augmented reality.

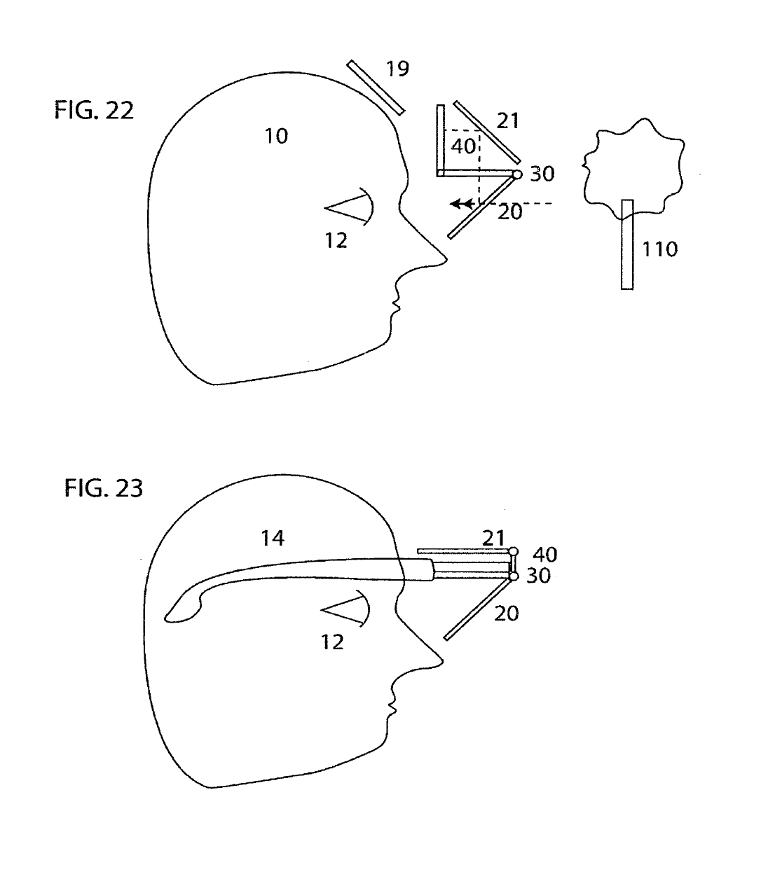

FIGS. 22-40 show a mixed/augmented/virtual reality headset 14 which may be in the form of normal eyeglasses, goggles, helmet visors, hats or visors: fixed or collapsible. The display may be a popular smart phone, any other display or custom display element including but not limited to OLED, LCD, QD, laser or other sources.

FIG. 22, 22A-G shows a preferred embodiment of the present invention having a first partial reflector 20, a first transmissive lens 30, a second reflector 21 and a display 40 affixed to a support structure 14 proximal to the user 10 forehead. A spacer 19 may be provided which provides improved stability, comfort, cooling or other qualities. The spacer 19 may be constructed from foam, fabric, cardboard, elastic or a composite of any materials and devices to provide the improved qualities. The composite may include but is not limited to a EMR (electromagnetic radiation) attenuator/reflector to reduce the EMR exposure of the user; a thermal insulating layer to reduce the heat transmit from the smart phone to the user; a passive or active thermal cooling layer to reduce the temperature of the smart phone; and/or a foam composite which conforms to the user's head shape and enhances the stability of the headset. The spacer 19 may have air-flow channels and hydrophilic/phobic fabric combinations to enhance cooling, comfort and moisture dissipation. The reflectors 20, 21 may be flat or curved, incorporating but not limited to transmissive, holographic, metamaterial optics as well as reflective elements. The first reflector may be a passive or dynamic partial reflector which overlays the display 40 image on the external environment, with optional global or pixelated, occlusion of the external environment 110. Reflectors may be partially coated, dichroic, diffractive, holographic, polarized or of other construction. The first transmissive optic lens 30 may be a flat or curved fresnel lens or other optical design of any material.

FIG. 22A shows the incorporating of an eye sensor camera 90, which may be the front camera on a popular smart phone. A external camera 80 may be utilized which in the case of the rear camera on a popular smart phone may include a waveguide image FOV displacement means which optically transfers the optical path to the proper front direction.

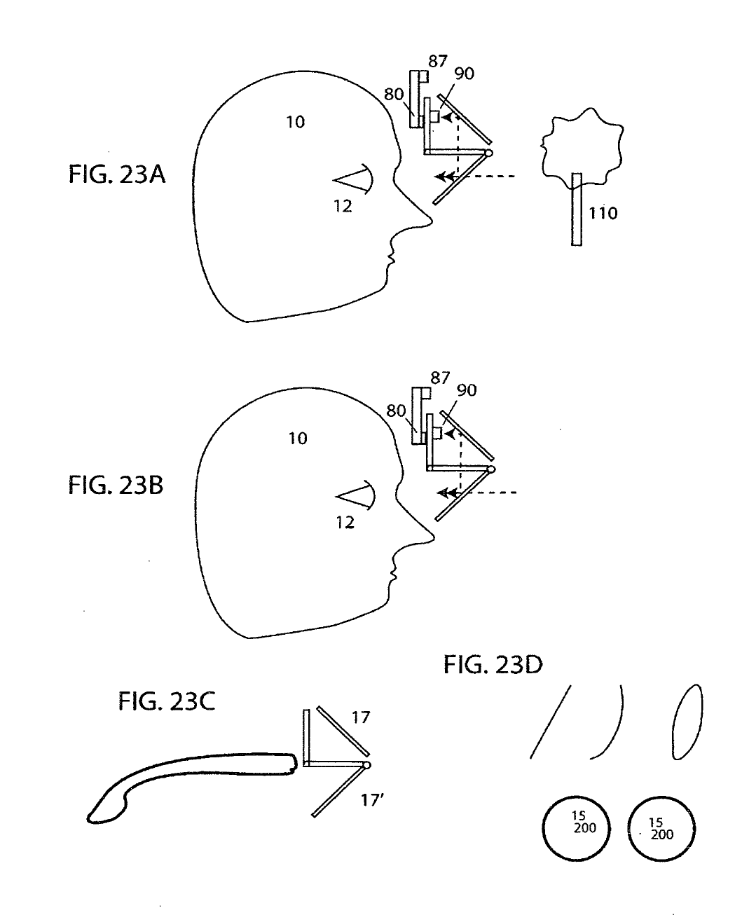

FIG. 23 shows a side view of the generalized, collapsible embodiment of the present invention where the display 40, the second reflector 21 and the first reflector 20 collapse, fold, disassembly or slide into a generally-flat visor-like structure 16. The structure may have ‘barn doors’ 17, 17′ to block ambient light. The visor 16 may resemble a common sun visor, may incorporate eyeglass-like arm structure 14 which may include audio components such as ear plugs or headphones of any type.

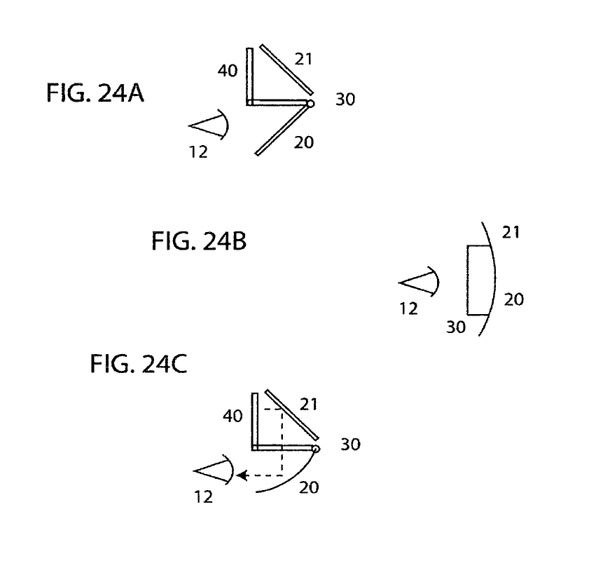

FIGS. 24A-C shows a planar (A), one-dimensional (B) and two-dimensional (C) construction of one or more of the optical elements: the first reflector 20, the first transmissive optic lens 30, and the second reflector 21. There is a multiplicity of permutations of the optical combinations including but not limited to:

A one-dimensional, horizontal dimension concave first reflector (20) with a compensating distortion of the display 40, first transmissive lens 30, and/or second reflector (21) shown as a convex shape.

A two-dimensional, concave first reflector (20) with a compensating distortion of the display 40, first transmissive lens 30, and/or second reflector (21) shown as a convex shape.

Permutations where the first reflector (20) is concave (or converging), the first lens 30 is diverging (and/or redirecting), and the second reflector is flat (or optional) achieve the similar means of transforming the display image 40 into a wide, field-of-view, over-laid image.

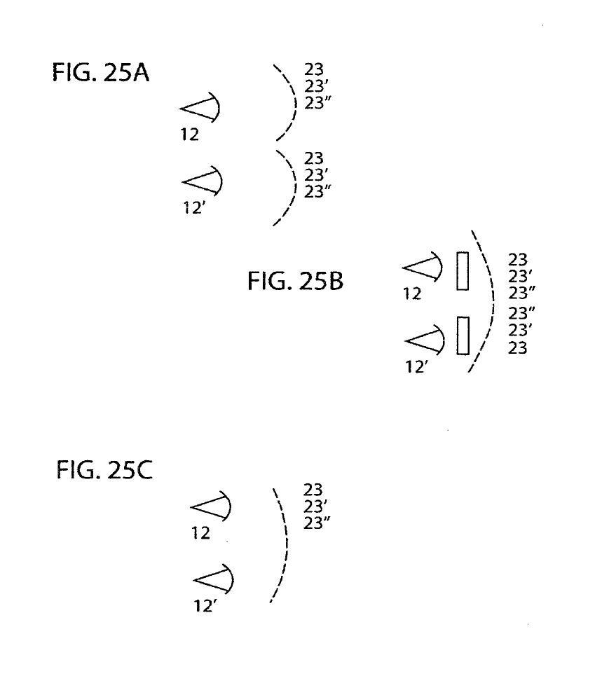

FIG. 25A shows a top view of a stereoscopic, segmented reflector embodiment of the present invention where each of the segments 23 . . . of the reflectors 20,21 may have an independent curvature (or flat) or focal length. FIG. 25C shows a monoscopic embodiment. When integrated with a multi-screen display algorithm such as employed by overlapping projectors, a smooth, continuous display image is created.

FIG. 25B shows a top view of a stereoscopic, segmented reflector employing microscopic, displacement retro-reflective optics 23A for the segments where the eyes field of view overlaps. The retro-reflective optics 23A directs the designated output from the respective eye's display to the eye in the horizontal or inter-eye axis while displacing the vertical axis to the appropriate display.

FIG. 25C shows a top view of a monoscopic, continuous or segmented variable reflector 20/23 employing a complementary

It may be understand that element 20, described as the variable reflection optic or see-through visor 20 in all embodiments may be full, reflective for virtual reality applications; of a fixed transmissivity/reflectivity ratio; or having a illumination-activated or user/program-activated, variable means such as but not limited to an electronically-controlled liquid crystal, E-Ink-type movable microelements, or additional, external occlusive layer.

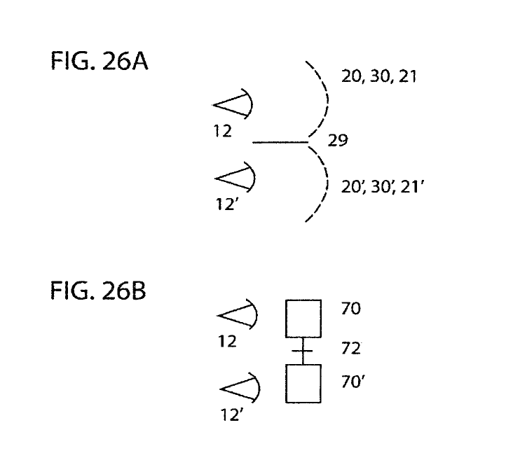

FIG. 26A presents a top view of preferred embodiment having a stereoscopic barrier 29 to prevent the overlap of the eye's field of view.

FIG. 26B presents a top view of preferred embodiment having a interocular distance adjustment 72. The means may be mechanical, and/or automated by measuring the interocular distance by the respective eye sensor camera 90. Additionally, or alternatively, the image on the stereoscopic display (two views as employed in virtual reality (Gear VR, etc) may be transformed.

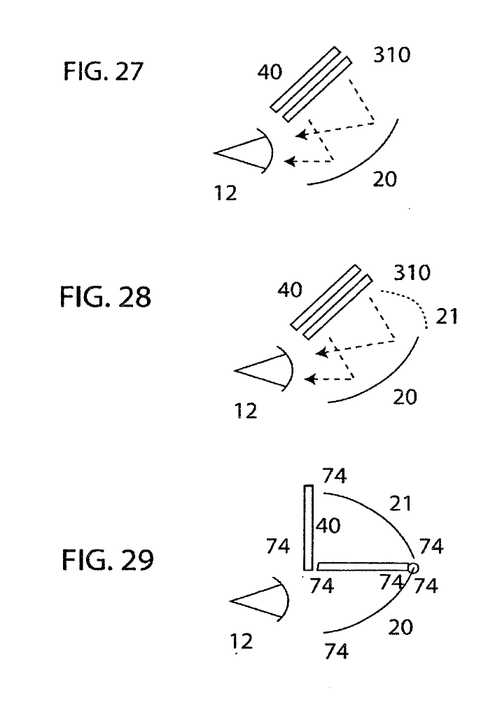

FIG. 27 presents a side view of preferred embodiment having Holographic Beam Director 310 (such as manufactured by Luminit—Direction Turning Films—and others) which may function as the means for the first transmissive optic 30 and the second reflector 21.

FIG. 28 presents a side view of FIG. 27 showing the virtual position of reflector 21 as shown in FIG. 29

FIG. 29 presents a side view of preferred embodiment having Focal Distance Adjustment means 74 which may be but is not limited to mechanical, electronic, photonic or other actuators, either manually or automatically controlled by means of user eye, physiology sensor means.

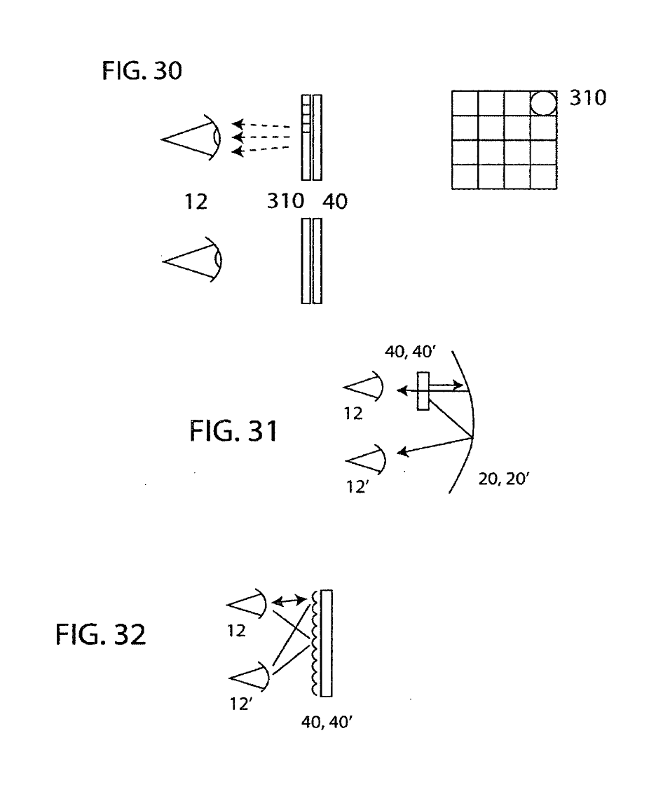

FIG. 30 presents a side view of preferred embodiment having accommodation means which may include methodologies disclosed in my parent applications, and may be generalized by ultrafine resolution, dynamic integral, beam direction or light field projections. Visual accommodation describes the human visual response of focal length which alters the shape of the eye lens. In my parent inventions, this may be achieved by a high resolution, dynamic scanning of a fine beam, the dynamic change of the focal length of a microlens associated with each display pixel, an ultrafine, integral lens display which may be fixed, dynamic or include a dynamic mask of apertures such as an FLCD over a OLED display.

FIG. 31 presents a top view of preferred embodiment having autostereoscopic means. Autostereoscopic describes a method of depth perception commonly achieved by image disparity between the left and right eyes, and not necessarily a difference in focal distance between the respective eye's displays or objects therein.

FIG. 32 presents a side view of FIG. 31

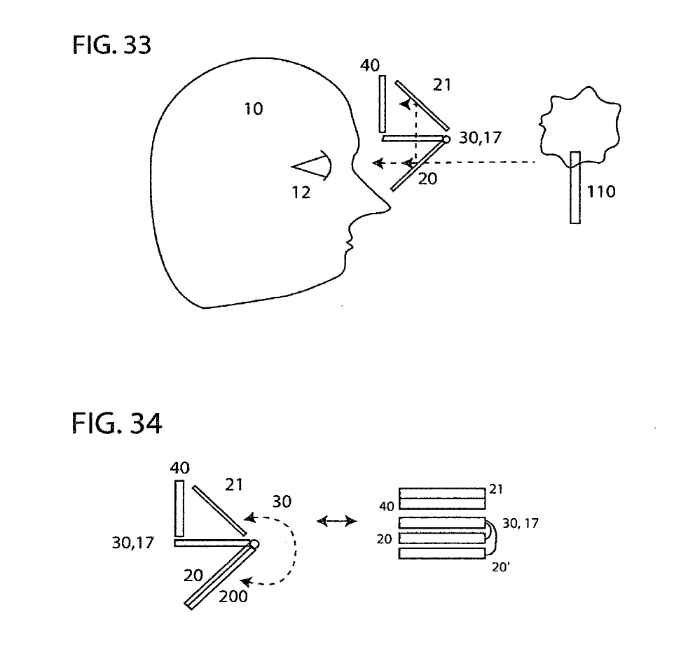

FIG. 33 shows a preferred embodiment of the present invention having an first partial reflector 20, a first transmissive lens 30, a second reflector 21 and a display 40 affixed to a support structure 14 proximal to the user 10 forehead. The reflectors 20, 21 may be flat or curved, incorporating optical as well as reflective elements. The first reflector may be a passive or dynamic partial reflector which overlays the display 40 image on the external environment, with optional global or pixelated, occlusion of the external environment 110. Reflectors may be partially coated, dichroic, diffractive, holographic, polarized or of other construction. The first transmissive optic lens 30 may be a flat or curved fresnel lens or other optical design of any material.

FIG. 34 presents a side view of a folded-state embodiment of FIG. X33 wherein a physical occlusive element 20D hinged to visor/supporting element 16/17 may occluded the external environment 110 from the vision of user 12 by blocking the view through the partial reflector 20, or alternately be stored proximal to the second reflector 21. In collapsed state, the occlusive element 20D may also be stored proximal to partial reflector 20.

The occlusive element 20D may be any opaque material including but not limited to paper, cardboard, plastics, ceramics, etc. It may be a thin film and stored rolled at the distal end of the visor 16/17.

The occlusive element 20D may also be of a variable density by means of mechanical displacing polarizing filters, electronically by liquid crystal, electronic ink or other photochromic method.

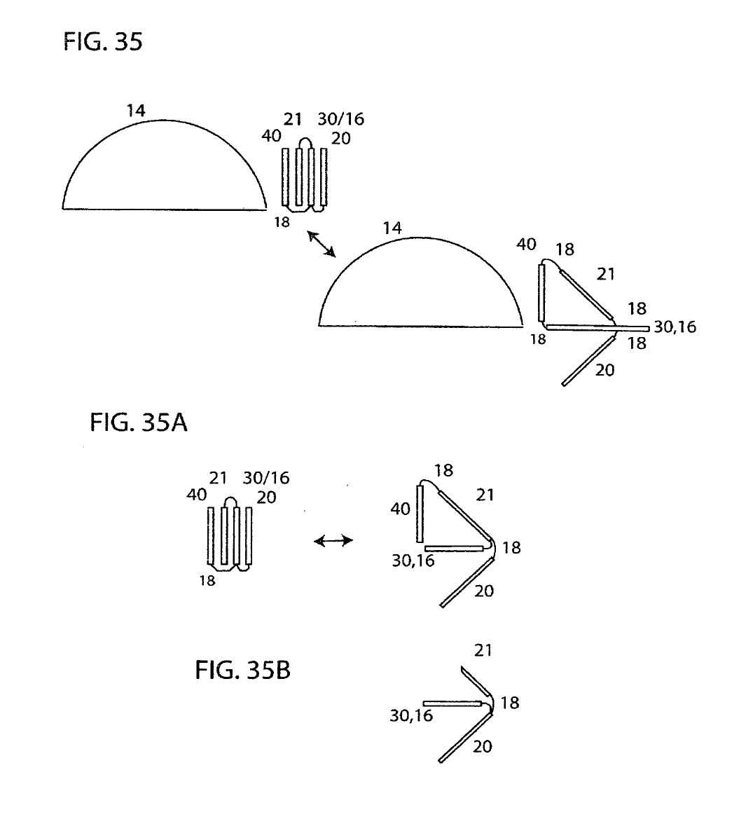

FIG. 35, 35A present a side views of a folded-state embodiment wherein the display means 40 is affixed to the user headgear (helmet, for example) 14 and the other elements stored in the collapsed state proximally. While the folding structure may also be applied to other configurations including the visor, hallmark card, armband, etc. as it is shown here.

In operation of one embodiment shown in FIG. 35, the display 40 is proximally hinged to visor/lens element 30/16. The first reflector partial element 20 and the second reflector element 21 are hinged to the visor/lens element are the distal side of the visor 30/16.

In operation of another embodiment shown in FIG. 35A, the display 40 is proximally hinged to second reflector element 21 which is distally hinged to visor/lens element 30/16 and the first reflector partial element 20. Alternatively, the first reflector element 20 is hinged to the lens element 30/16.

Not shown are fasteners to secure the elements 20,21,30,40 to the headgear/visor 14/16. One embodiment may employ tabs with Velcro or insertable clasps. These also may be magnetic, snaps, Velcro, clasps and other well-known means of securing. The elements may have tabs, inserts, posts, protrusions, screws and other well-known means of registration and securing cardboard, origami, cabinets, helmets, cameras, goggles and other devices having a movable structure.

Not shown are “Audience Effects’ receiver and transmitter means described in detail in my co-pending application Ser. No. 13/294,011 incorporated herein by reference. The receiver, transmitter and other related means may be located in any location.

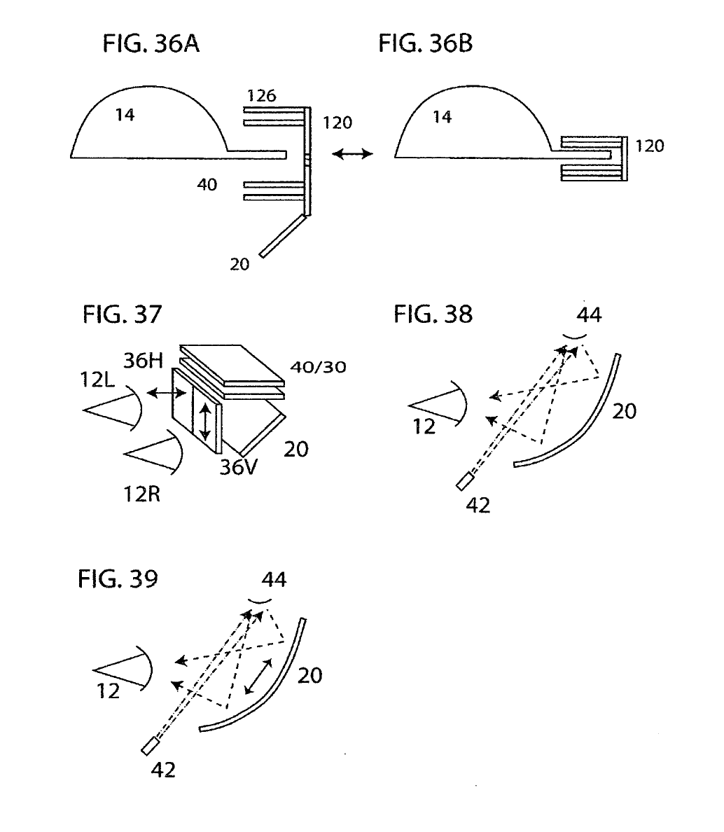

FIG. 36A presents an embodiment which attaches by any means including but not limited to clips, magnets, latches, snaps, Velcro or other fastener, to a visor 14, baseball cap or other object having a battery/electronics/wireless 120 on the upper side of the visor 14 means connected to the display 40, lens optics 30, and reflector 20 on the lower side of the visor 14 means, The display 40, lens optics 30 and reflector may be articulated to collapse into the visor 14 as shown in FIG. 36B.

FIG. 37 presents a polarized embodiment enabling a stereoscopic presentation from a combined display/optics means 40/30 having a first polarizing means 36M which may be a passive array or matrix of opposing polarization domains or an active polarizing layer such as a polarizer/liquid crystal combination; and a second polarizing means 36V, 36H of matching opposing polarizations placed in the unique optical path to each eye 12R, 12L. In passive operation, the display image is interlaced with a left eye image polarized in one state (linear—vertical, horizontal: circular—left, right handed) and the right eye image in another. By setting the corresponding second polarizer in a matching state only the left eye image is transmitted to the left eye 12L and only the right eye 12R image is transmitted to right eye.

Not shown but similar in configuration to FIG. X37 is an alternating eye, stereoscopic presentation where a full display image 40 is alternatively presented to each eye 12L, 12H by means of an alternating occlusion plate 36A—Left, 36A—Right, which at a rapid frequency commonly greater than 60 HZ alternately block out the display image 40 to each eye.

FIG. 38 presents a scanning projection embodiment having a display projector 40 which may be but is not limited to a 1D/2D scanning laser 42 projecting a scanned beam to a distortion-corrected screen surface 44 to the first reflector 20 and then the user's eye. This method enables a complex first reflector 20 design affording higher field of view without image distortion or non-uniformity in a compact, lightweight, power efficient embodiment.

FIG. 39 shows one possible scan direction of the scanning projector shown in FIG. 38.

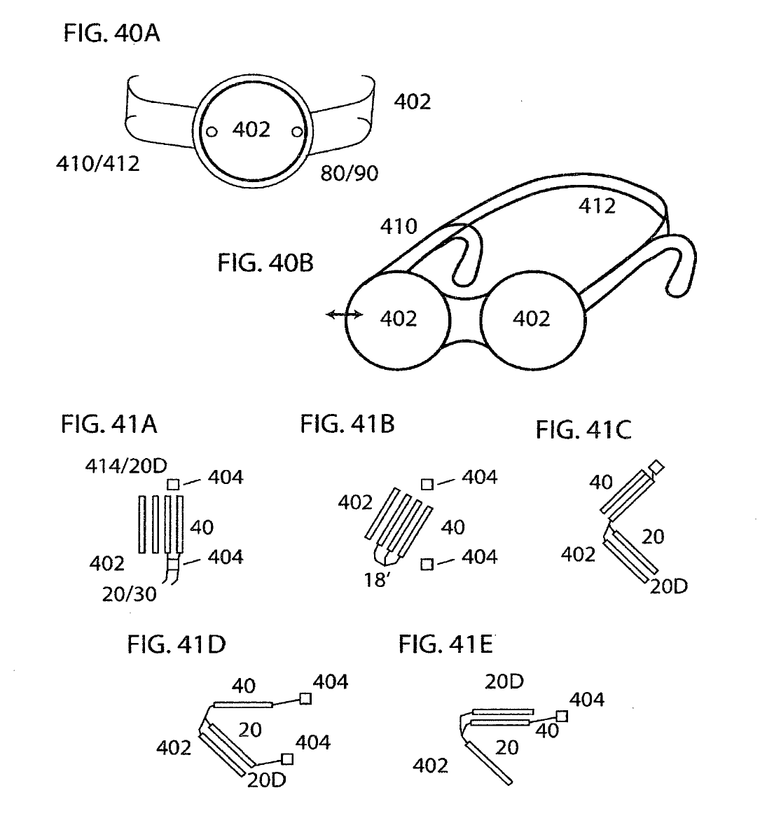

FIGS. 40A, B present a front view of a watch/eyewear embodiment 400 of the present invention having a watch/eyewear assembly 402 movably attached to watch/eyewear frame assembly 404. As discussed in detail in my co-pending application U.S. Ser. No. 14/189,232 which in incorporated herein by reference, the frame assembly 404 may transform from a watch with a wristband 410 to eyewear with arms, earpieces and/or a head strap 410/412.

FIG. 41 A-E presents an exploded, side view of the transformation of the watch/eyewear assembly 402 the display 40 which may be but is not limited to an LCD, OLED, QD or other visual display in viewer in a watch configuration in (A) having the transform optics 30, partial reflector 20 and occlusive element 20D positioned on the backside (wrist side) of the display 40.

In the transformation, the assembly 402 is shown folding out from the frame 404 by means of hinge 18. Not shown are many alternative hinge-connector transformations including removing and transforming the assembly 402 and reattaching it to the frame 404 which are incorporated by reference herein. As shown in (C-E), the display 40 transforms to a position approximately 90 degrees to the plane of the frame 404 with the transform optics 30 moved proximal to and in the optic path of the display 40. The partial reflector 20 is moved to a position approximately 45 degrees to the frame 404. The occlusive element 200 may alternatively by moved to the back (top) side of the display 40 or to the outside of the partial reflector 20 thereby providing a fully immersive ‘virtual reality’ experience excluding the external environment 110 viewable in the ‘augmented reality’ mode.

An external camera 80 and eye camera/sensor 90 may be provided.

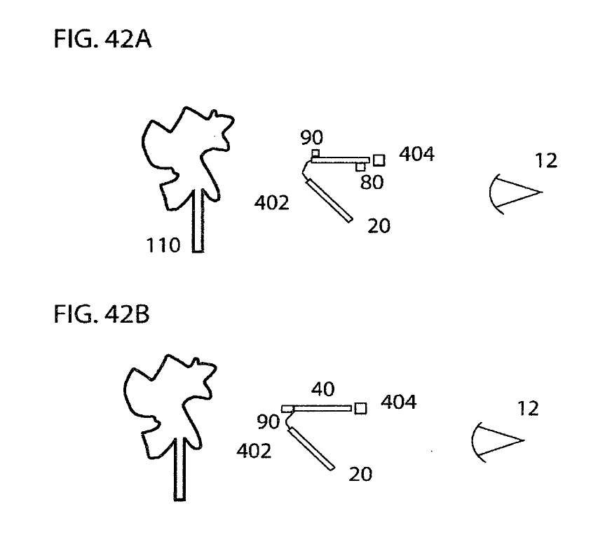

FIG. 42A, B presents an exploded, side view of the transformation of the watch/eyewear assembly 402 having an external camera 80 and eye camera/sensor 90 and optical and/or mechanical means to redirect the optic axis. In one embodiment, the optic axis of the external camera 80 is orthogonal to the watch/eyewear assembly 402 in the watch mode and is redirected to be parallel to plane of the assembly 402 in the eyewear mode thereby capturing images of the external environment. Alternatively, multiple cameras 90 may be provided including one integrated into the frame assembly 404.

A separate eye camera/sensor 90 may be provided, which may be affixed to the display 40 and captures the user's eyes 12 in eyewear mode.

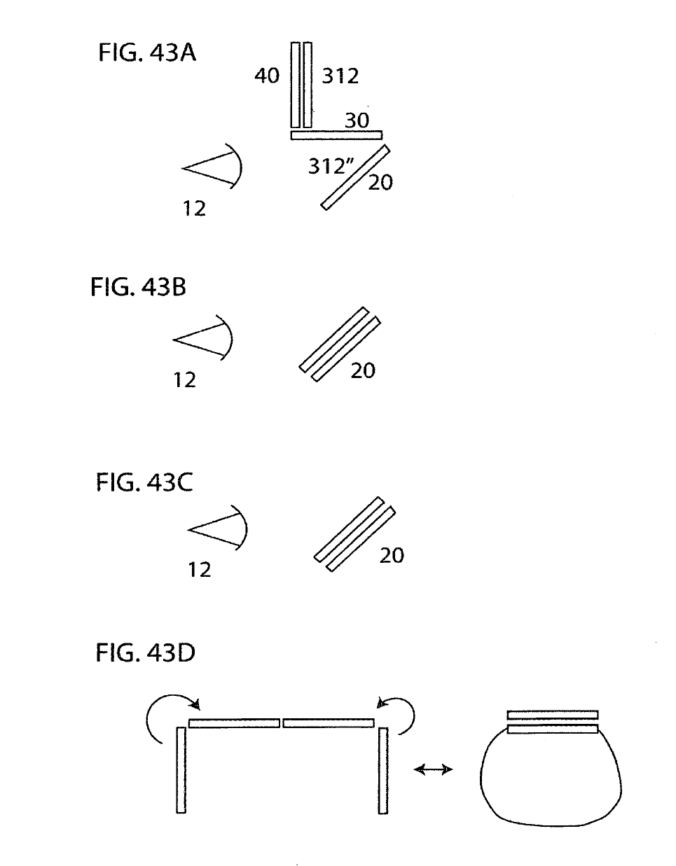

FIG. 43A-D presents a polarization embodiment of the present invention where the display image is polarized by active polarization filter 312′ and separately present to each eye 12 by opposite state polarizers 312″,312′″ to each eye.

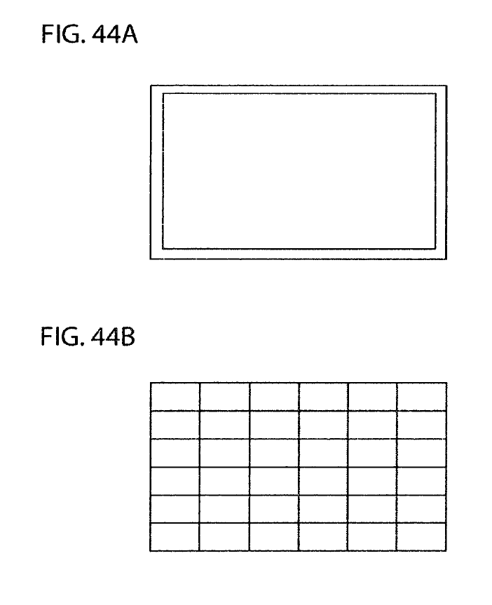

FIG. 44A, B presents a front view of dynamic optics in the form of full lens, fresnel lens or FIG. X44B a matrix of lenses, having a dynamic structure which may employ but is not limited to electrostatic forces, electrostriction, ion insertion, molecular conformational, liquid crystal, fluidic, mechanical or other methods. Some of these dynamic-focus methods are commonly found in smart phone cameras and eyepieces.

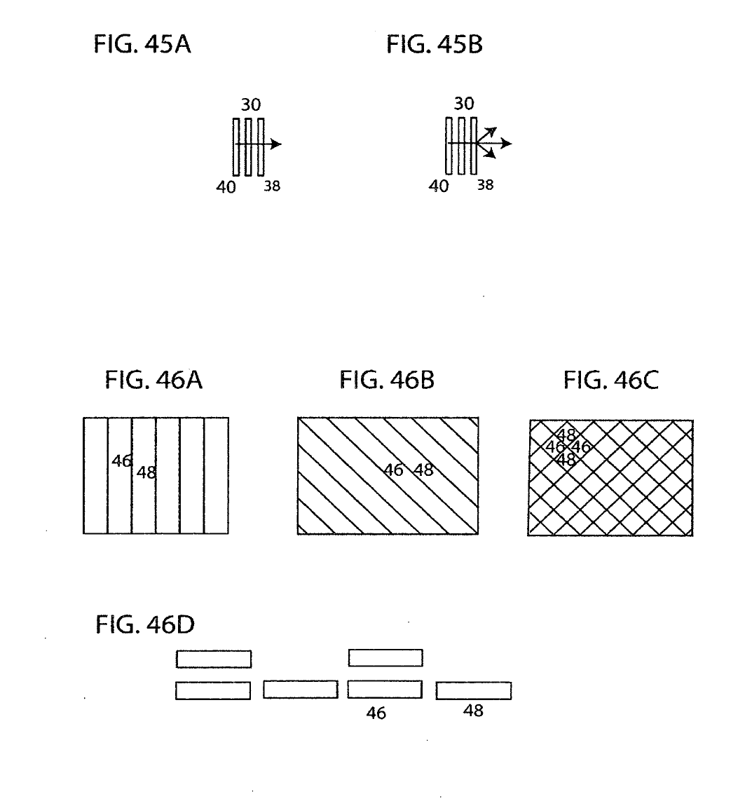

FIG. 45A, B presents a side view of transparent-eyeglass mode/diffusive-watch mode display 40, optics 30 and transparent/diffusive screen 38 embodiment. The focal length of the optics 30 may be fixed or adjustable. In eyeglass mode, the screen 38 is transparent and the display 40 has a focal length defined by the optics 30. The focal length commonly set at 6 feet to infinity when viewed by the human eye in eyeglass configuration. In watch mode (used as a normal watch, smart phone, etc. for viewing at normal, comfortable watch/book distance—approximately greater than 12″), the screen 38 is diffusive and acts as a rear projection screen with an angle of diffusion enabling the eye to focus upon the screen 38. The angle of diffusion may be large for a wide field of observation or narrow for a ‘privacy’ and/or higher brightness/power efficiency screen.

Fixed optics 30 may be in the form a regular or fresnel lens, a matrix of lenses, or dynamic structures which may employ but is not limited to electrostatic forces, electrostriction, ion insertion, molecular conformational, liquid crystal, fluidic, mechanical or other methods. Some of these dynamic-focus methods are commonly found in smart phone cameras and eyepieces.

FIG. 46 presents a front view of a display 40 having a mosaic of clear 48 and active display 46 regions. The active display regions may be pixelated. When constructed in micrometer dimensions at or higher than the eye's resolution, the display 40 will appear as partially transparent window is the off-state and as an active display screen 40 in the on-state. The regions 46, 48 may be of any pattern including but not limited to linear (a), angular (b) or a matrix (c).

The active display regions may be pixelated and overlaid with a static or active optics 30 and shown in a side view FIG. X46d.

The transparent/diffusive screen 38 may employ but is not limited to photoactive polymers, liquid crystals or other technologies including a variant of the photochromic method employed in the commercially-available ‘clear-to-privacy’ electronic windows.

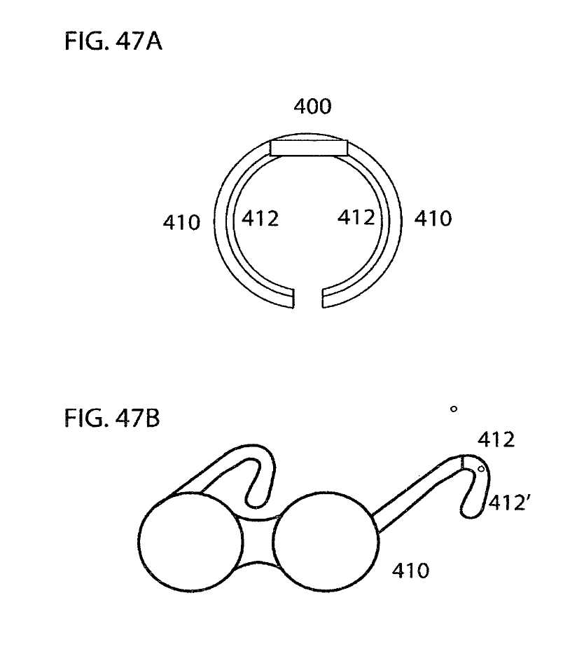

FIG. 47 presents a side view of an watch-eyewear embodiment 400 having a wristband 410 which converts into eyewear arms by means of a folded eyewear arm assembly 414.

Cardboard-Smartphone

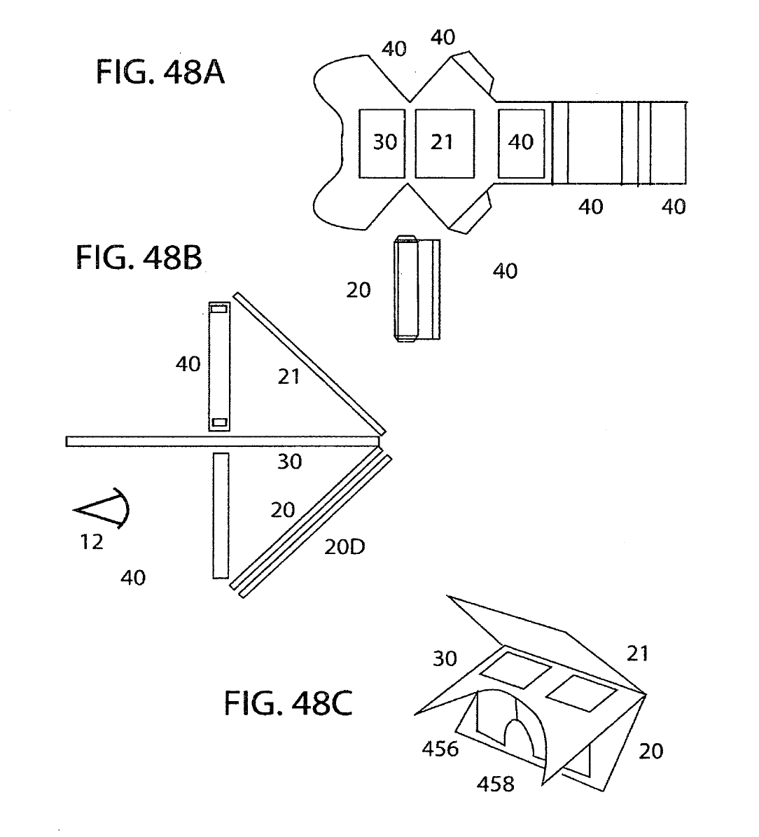

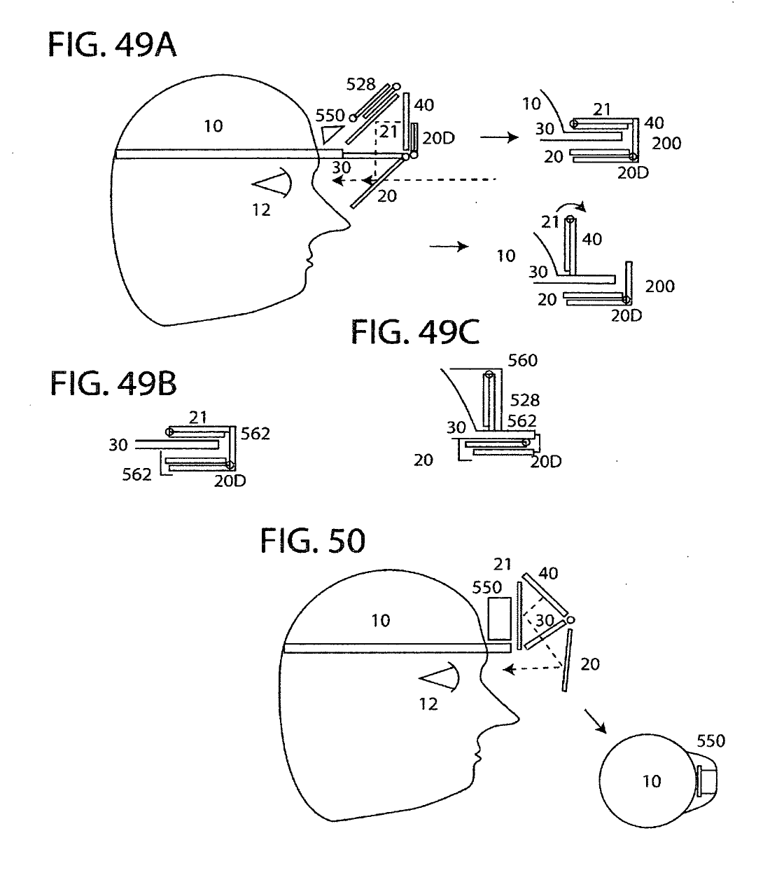

FIG. 48A presents a top view of a ‘cardboard’ embodiment of the present invention. ‘Cardboard’ is a term currently used in virtual reality industry to describe a series of popular re-design of the Viewmaster stereoscopic technology for use with current smart phones. This embodiment may be constructed of two major parts: the main part may be constructed from any material including but not limited to cardboard, matteboard, plastic, foam, wood, ceramic, carbon fiber, etc. with folds shown as transverse lines having an aperture 30′ to hold optics 30, a surface to affix reflector 21, an aperture 40 to enable the image of the smart phone display 40 to be view.

In operation, the main part is folded as shown in (B) wherein the part containing the optics aperture/holder 30′ becomes a horizontal ‘visor’ to which the partial reflector 20 is affixed, the next main part containing the second reflector 21 is folded upwards positioned at the proper angle by transverse flaps and held in place by tabs (t) which may be Velcro, snaps or other fastener. The next main part containing the ‘smartphone’ display 40 aperture is folded downwards and then into a closable box to hold the ‘smartphone’, the bottom of which may be affixed to the ‘visor’ part (d). The next main part is folded forwards to secure the ‘smartphone’. It may extend to form an occlusive element 200 which may be folded back upon itself in ‘augmented’ mode and over the partial reflector 20 in ‘virtual, immersive’ mode.

Apertures with optional insert flaps or buttons may be provided to activate the smart phone controls and touch screen.

Additionally, elements may include a means to redirect the rear camera 90 of the smart phone to a forward, external environment view, a means to redirect the front camera 80 of the smart phone to view the user's eyes 12.

Inserts 460 may be provided to adjust the position of different sized smartphones, eye prescription and other variables.

The ‘cardboard’ design may include an intra-ocular insert 458 and individual optics 30′, 30″ which transforms the design from a mononscopic to stereoscopic mode.

Additional enhancements include complex, curved reflectors 20, 21 monoscopic or stereoscopic to increase the field of view and other characteristics described elsewhere in this application.

An additional nose support piece (not shown) may be provided to

FIG. *49 presents a side view of an smartphone, camera-out embodiment of the present collapsible visor embodiment of the present invention where the display 40 is positioned distal to the forehead of the user 10 and may fold either flat on the brim/lens assembly 30 and protected by second reflector 21 shown in FIG. x49A or proximal to the forehead as shown in FIG. x49B and protected by movable panel 528. The first partial reflector 20 may fold flat against the brim/lens assembly 30 protected by the occlusive panels 200.

FIG. 50 presents a side and top views of the supporting forehead cushion 550 placement of the present invention.

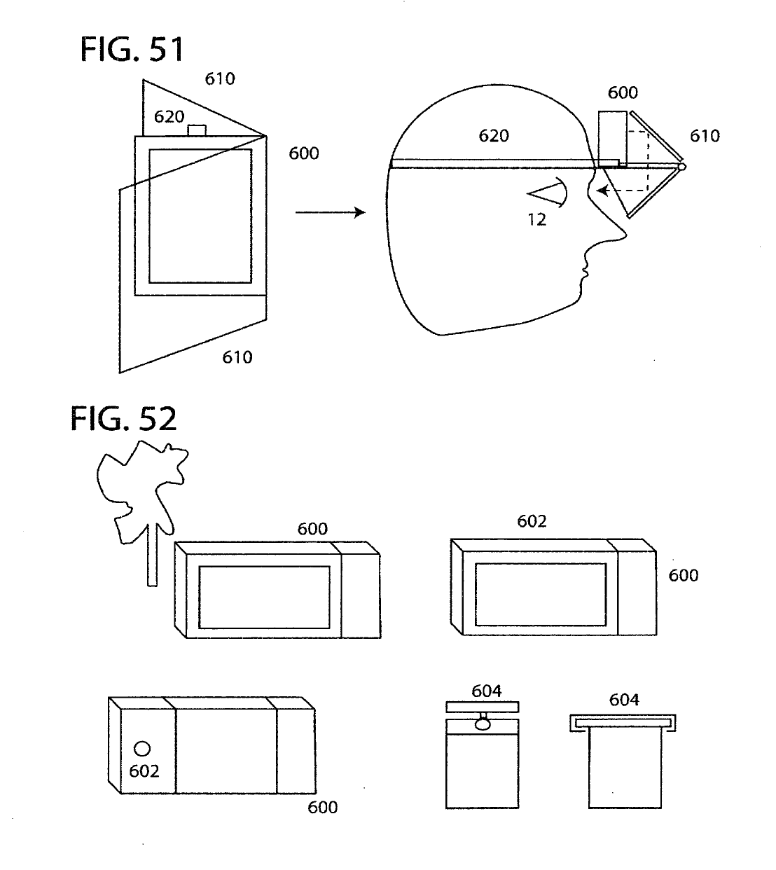

FIG. 51 presents a perspective views of an expandable case embodiment of the present invention wherein the expandable case 600 may have one or more elements 610 which contain the full display/mirror/lens assembly in collapsed visor form as shown in other Figs herein and may be expanded as shown in FIG. x51(B).

FIG. 52 presents a perspective views of an expandable case embodiment with a slide function 604 which enables the use for smartphone 602 camera 602′.

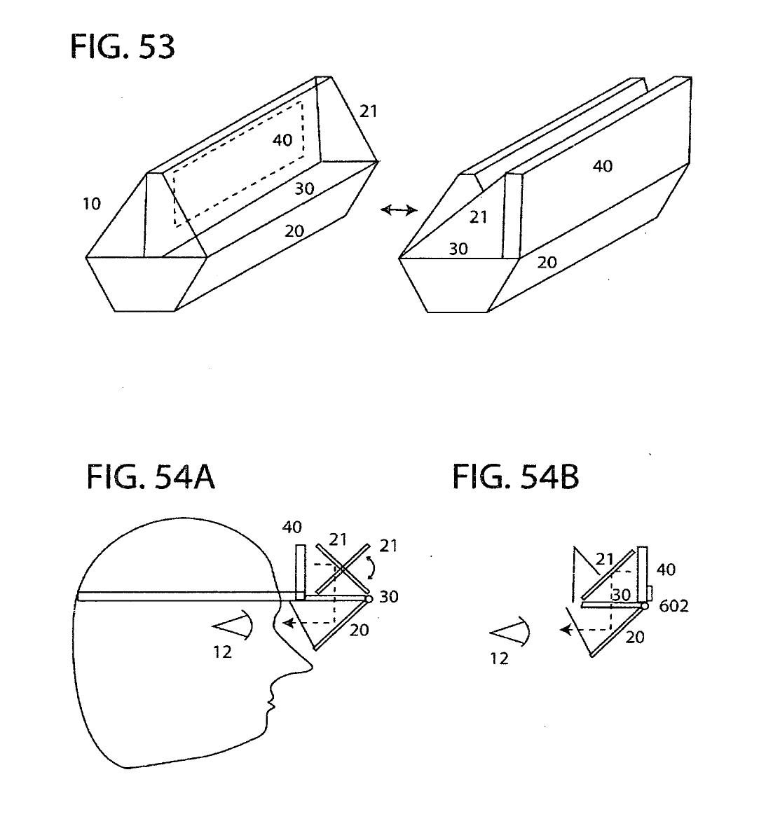

FIG. 53 presents a perspective view of transformable, multiple orientation, embodiment of the present invention where the second reflector 21 is movable or pivotable about axis 21′ from a direction facing towards the user 10 to a position away (B) from the user 10. The display/smartphone 40 is also movable from a position proximal to and display facing away from the user 10 to one distal (B) with the display facing towards the user 10. In the (B) configuration the smartphone main camera 602′ would be facing away from the user 10.

The construction may include a pre-fold or hinged support, light shields and fasteners to register the two configurations properly.

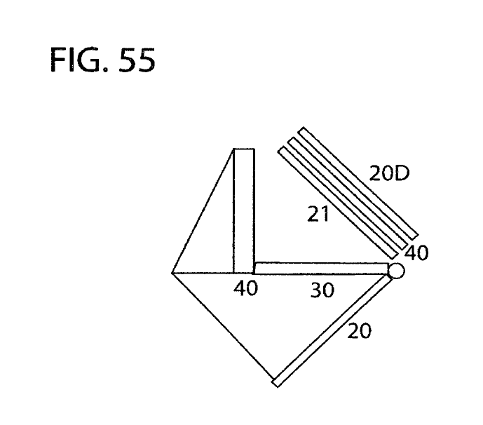

FIG. 54 presents a side view of transformable, multiple orientation, embodiment of the present invention where the second reflector 21 is movable or pivotable about axis 21′ from a direction facing towards (A) the user 10 to a position away (B) from the user 10. The display/smartphone 40 is also movable from a position proximal to and display facing away from the user 10 to one distal (B) with the display facing towards the user 10. In the (B) configuration the smartphone main camera 602′ would be facing away from the user 10. The (B) configuration optical path from the display 40 to the user 10 is shown.

FIG. 55 presents a side view of a transformable, multiple-orientation embodiment of the present invention where (A) configuration includes which stores affixed to the outer side of the second reflector 21. A Virtual Reality occlusion panel 20D is shown stored on the outer side of said second holder 40″.

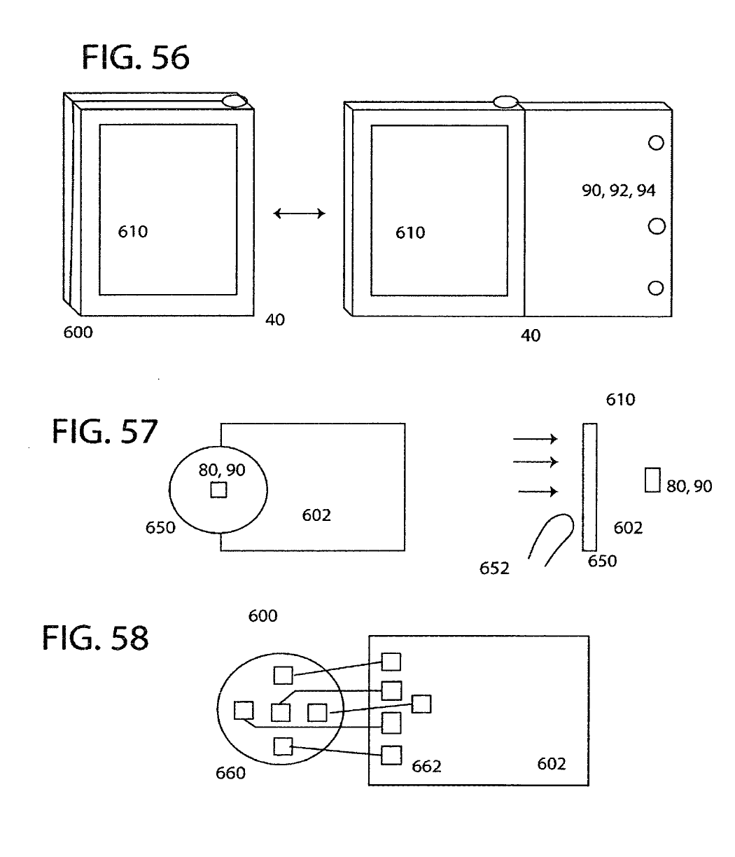

FIG. 56 presents front view of a transformable, multiple-orientation embodiment of the present invention where (A) configuration includes a smart phone case 600 and a hinged second display/smartphone holder 40″ and a second panel 610′ which houses cameras 90, 92, 94.

FIG. 57 presents front view (a) and side (b) view of a gradient or segmented chromatic overlay 650 which is imaged by a optical sensor which may include a smart phone camera 80,90. The chromatic overlay 650 may be illuminated by ambient or other light source. When said overly 650 is occluded by a finger, pointer or other device 652, the chromatic shift is recorded by the computational unit (not shown) and the designated program is executed.

FIG. 58 presents top view of a conductive template 660 transfers to corresponding touch pads 662 on the smart phone surface 602.

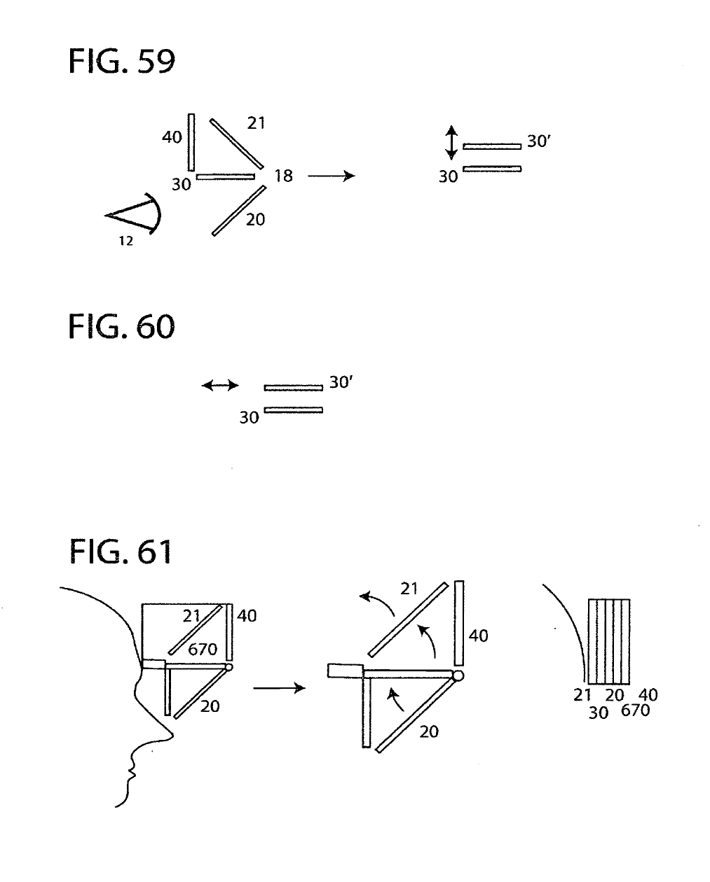

FIG. 59 presents side view of a zoom optic 30′, 30″ applied to the optic 30 of the present invention. Said overlay optic results in a variable zoom function by orthogonal displacement along the optic axis.

FIG. 60 presents side view of an overlay fresnel optic 30′″, 30′″ applied to the optic 30 of the present invention. Said overlay optic results in a variable zoom function by parallel displacement to said optic.

FIG. 61 presents a side view of a collapsible embodiment of the present invention where foldable side panels 670 enable the enclosure of the optical elements 20, 30, 21 in a volume covered by the smart phone or equivalent unit 40. Said embodiment enables the recording by the external smart phone camera in both the closed and expanded position. Multiple permutations are shown including but not limited to sliding or hinging first reflector/view mirror 20 into its folded position.

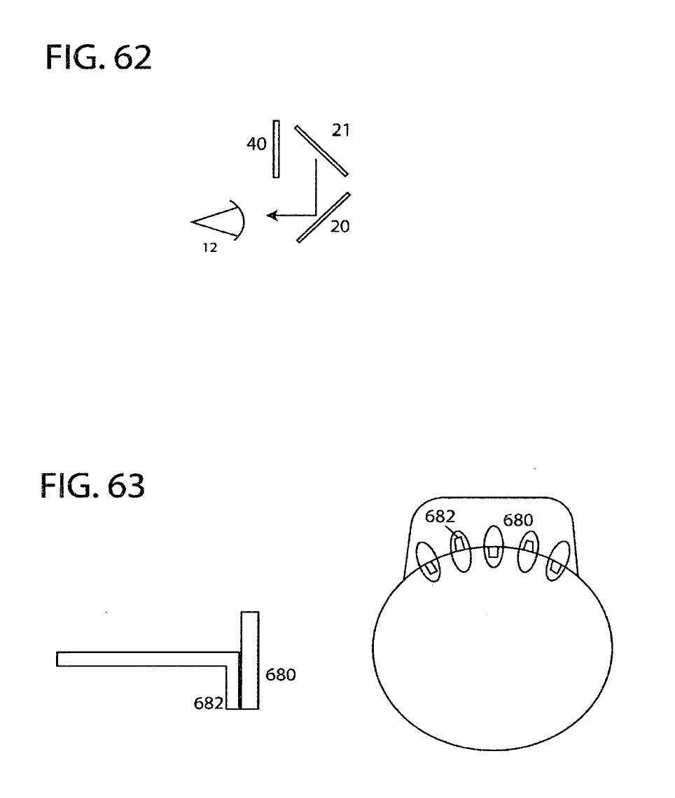

FIG. 62 presents a side view where the first reflector/view mirror 20 includes a variable density/reflective/transmissivity means. This may be incorporated in a single layer by means of known electro-holographic elements, electro-dielectric, liquid crystal technology or E-Ink methodology. This may also be incorporated in multiple layers were a first layer varies the reflectivity/transmissivity and a second layer varies the ambient occlusion.

FIG. 63 presents a side (a) and (b) view of a tab, foldable cushion embodiment shown for, but not limited to, the brim/forehead region of the headgear 14 element of the present invention, where a foam cushion pad 680 is affixed to a foldable tab 682, such that the combination may be in a “use” configuration (a) providing a flexible cushion for a user's forehead and transformed into a flat ‘storage’ configuration (b).

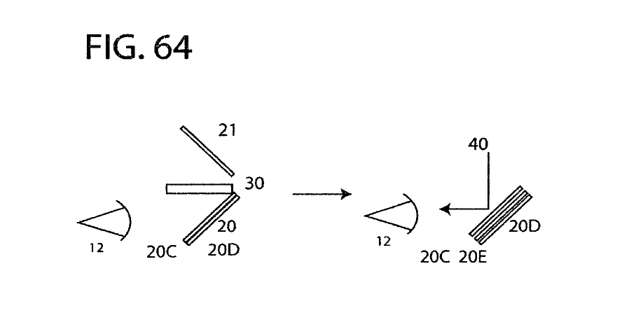

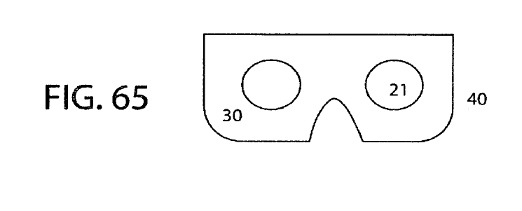

FIG. 64 presents a side detailed view of preferred embodiments of the occlusive element of the present invention. In earlier pending applications, an ambient or user controlled electro or photochromic occlusive element in described which controls the transmissivity of external light through the composite reflective element 20. This may be controlled automatically by the photochromic effects of the external ambient light (a bright outdoors environment) or user-controlled for situations where the occlusion of the external environment is desirable, either over the entire reflective element 20 or selectively in regions where, for example, data is displayed. The level of control may vary according the complexity of the final product from binary to graduated, pixel region specificity.

FIG. 64 further presents a side view of photochromic activation barrier layer 20E placed between the internal reflective layer 20C and external, occlusive photochromic layer 200. Said layer 20E prevents the emission from the display 40′ from activating the photochromic layer 20D.

FIG. 65 presents a front view of a first reflective view mirror 20 having variable transmissive/reflective regions 20′, 20″. Multiple permutations are presented including to not limited to a central region 20′ of higher transmissivity than the surrounding region 20″. The regional transmissivity/reflectivity may be fixed or variable by known means including but not limited to mechanical, photonic and electronic controls.

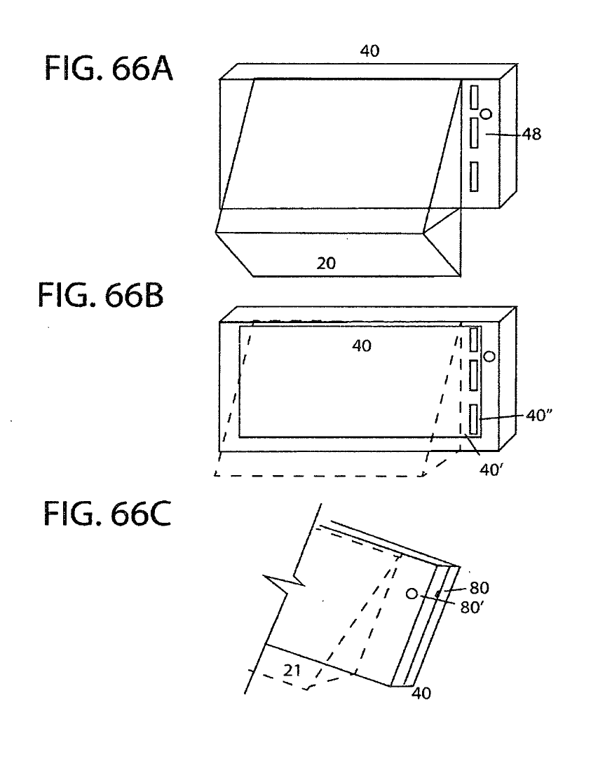

FIG. 66A presents a perspective view of a direct front camera embodiment of the present invention where a portion of the side supporting structure of the second mirror 21 is flanged to hold an aperture for the direct view of the front camera 80,90 of the display phone 40 and a series of actuate buttons 40″ which are positioned on the display screen or actual, corresponding buttons of the display 40.

FIG. 66B presents another perspective view of a direct front camera embodiment of the present invention where the supporting structure is shown in dashed lines, and the active region of the display 40′ is activated by pressure/electrostatic flange regions or buttons 40″.

FIG. 66C present a upper side perspective view of the present invention showing the camera aperture of the supporting flange of the second mirror 21, the display 40 and the front phone camera 80,90.

It may be understood that the computer program displaying the front camera or other images/data may be assigned a region within the center display and the activation region of the buttons placed on the perimeter. Alternative and dynamic configurations may be employed.

The front camera 80,90 may be used directly for target recognition and other functions related to augmented reality employing software such as but not limited to Vuforia® or OpenCV®.

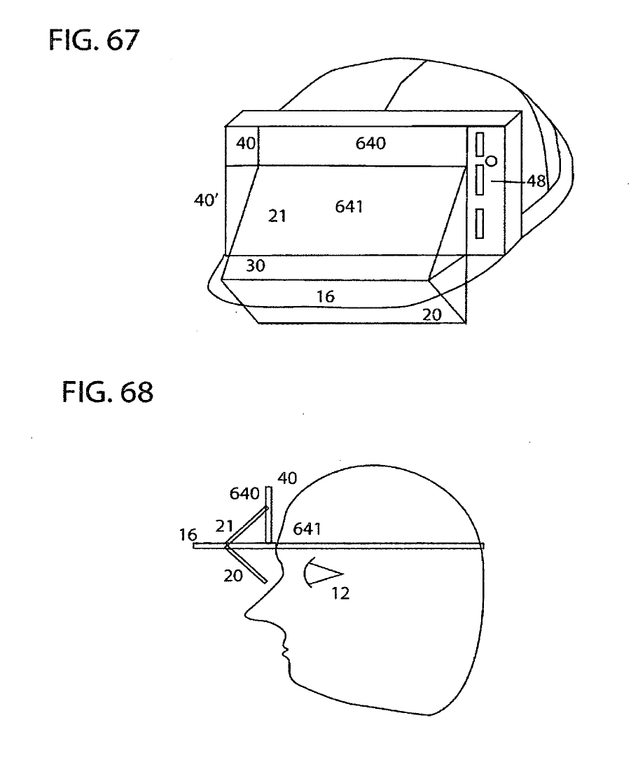

FIG. 67 presents a perspective view of a Reduced AR Optics System embodiment of the present invention showing the reduced AR Optics System 641 having a first reflector mirror 20, lens means 30, second reflector 21 and display means 40 which may typically be a smart phone or other display device. Around at least one segment of the perimeter of the AR system 641, a section 40′ of the display means 40 is either visible through a clear/transparent or translucent cover 640 or directly visible and accessible through an aperture in a display means 40 frame system 642.

In operation, the visible/accessible section 40′/640′ of the display means 40 may be used to display the USER NAME, colors, text, shapes, forms and any other information, art, signals or other use. For example, the color and information may be used at events, classrooms, seminars for ticketing, status, and effects. At a trade show or classroom, the user's name may be displayed with a color indicating the user's status and other information. In a game, a ‘hit’ may be indicated by a flashing color, the health by the color. At a concert, the color may be controlled by the show designer to create a message, pattern or other effect in the audience. In an art show, a myriad of color, shape, motion, sound, vibration and other effects may be employed.

The camera 80 may be used to register the position of the each user by a code on the seat or location (QR code), triangulation of targets in the venue, by a photonic or electronic beacon, or other means.

The visible/accessible section may have ‘virtual buttons, sliders, etc’ 644 activated by the user.

The visible sections 40′/640′ may be used for identification in conjunction with wireless communications including Bluetooth, Wifi, etc. and/or external visual cameras which may identify and map the user location and orientation. The data created may be used for any use including but not limited to security, show design and execution, and gaming.

FIG. 68 presents a side view of the Reduced AR Optical System embodiment of FIG. x67.

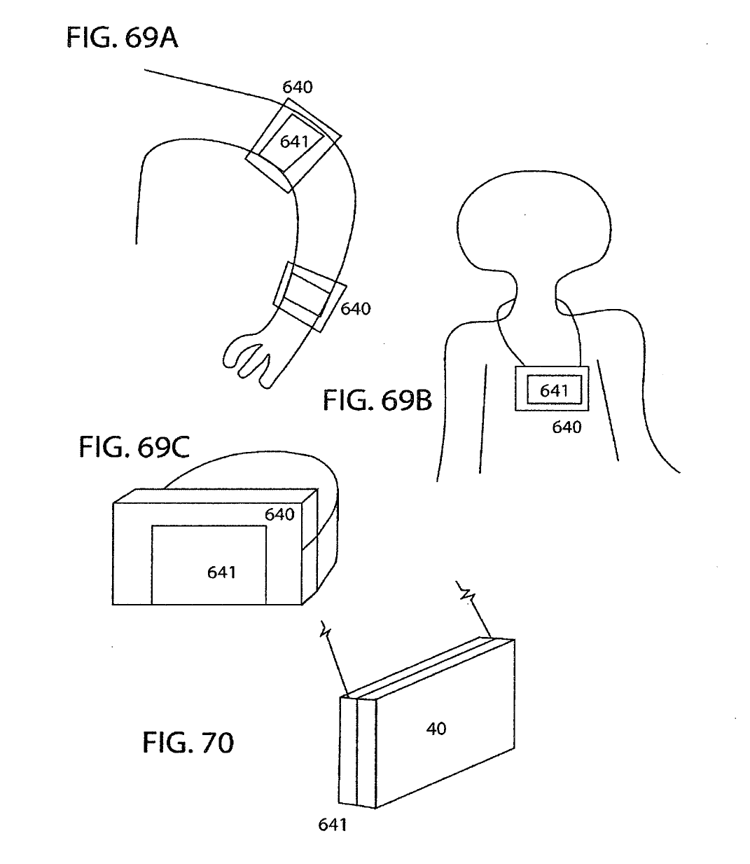

FIGS. 69A, B, C present variants of the mounting and use of the present invention as a (a) arm or wrist band; (b, b′) an identity badge or (c) handheld.

FIG. 70 presents a perspective view of the identity badge embodiment having the display 40 viewable with the AR system 641 folded behind and thus adjacent to the user 10.

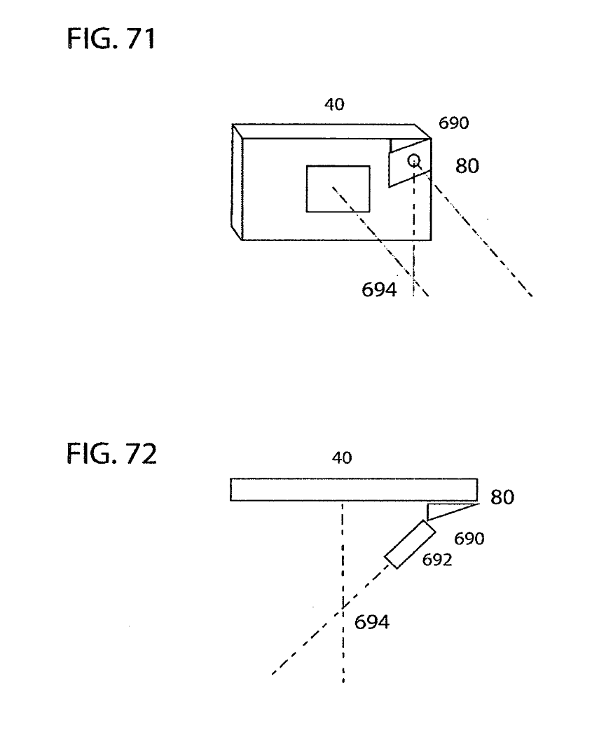

FIG. 71 presents an optical centering embodiment of present invention having a first optical element 690 which redirects the principal optical axis of the camera 80 to a designated vector. Said vector may intersect the normal of the display 40 at a designated distance, fixed or variable. In a simple embodiment the point of intersection may be approximately 10 feet from the user. A distance may be designated.

A further complexity of the first optical element 690 may include means to alter the beam path, including but not limited to a fixed optical wedge; prism; an optical pipe or fiber; a lens normal, Fresnel, holographic, diffractive; a variable optical wedge(s) incorporating motion of solid elements, liquids, electro-holography or other optical technology known to redirect the optical path

The optical centering embodiment, in static or dynamic form, may also be used to track hand motions, hand controllers and other close targets.

FIG. 72 presents a top view of the present invention. The second optical element 692 may be provided having the characteristics of a telephoto or other lens to alter the field of view of the smart phone camera. First and second optical elements 690, 692 may be combined. In the telephoto embodiment, a more distant ‘Vuforia target/object’ may be recognized than using a wide-angle lens. Vuforia is a well-known target/object recognition software employed in contemporary augmented reality products.

Application Elements of the Present Invention

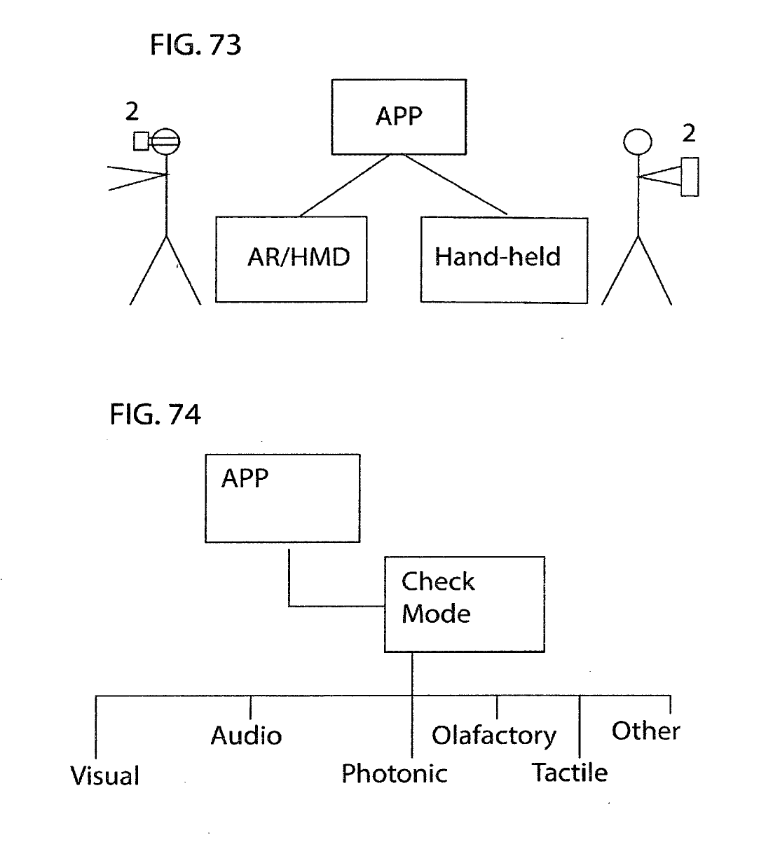

FIG. 73 presents a schematic view of a representative consumer application having at least two modes—head mounted mode and handheld mode.

FIG. 74 presents a schematic view of representative game application having optional external target recognition by visual, audio, electronic, photonic, olfactory, tactile or other means,

Performance Effects Elements of the Present Invention

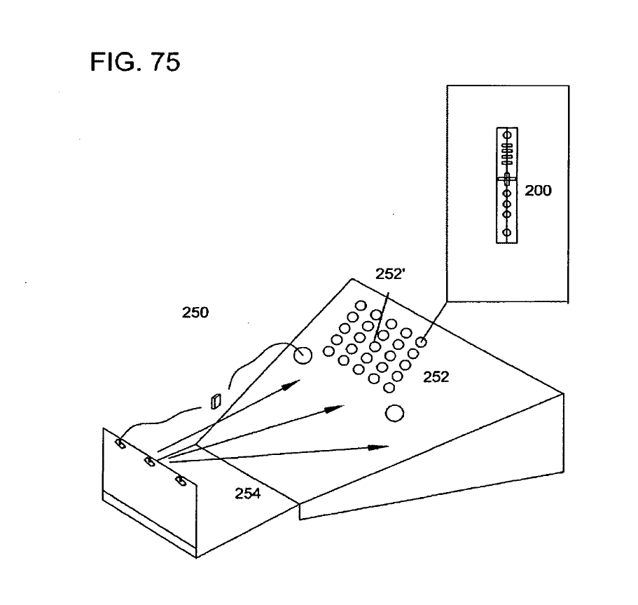

FIG. 75 presents the generalized elements of the performance display system 250 in a venue resembling an audience 252 with a plurality of audience members 252″ and stage 254. In the present invention, the headset 2/15/200 and accessories may each function as a performance audience unit as described in my co-pending, parent patent applications cited and incorporated herein in its entirety. The headset 2/15/200 may The venue may include any space ranging from the interior of an automobile, a living room, a dining hall, or nightclub to major event venues such as theatres, concert halls, football stadiums or outdoor festivals. Although the term audience unit or audience receiver unit 200 is used to describe both the simple and autostereoscopic-effects unit, it may be understood that the module may take any shape or be incorporated into any headset 2, glasses 14, transformable smart watch 400, independent handheld, worn, or positioned effects device including but not limited to tickets, badges, buttons, globes, cylinders, signs, sashes, headdresses, jewelry, clothing, shields, panels and emblems affixed or held to a member of the audience or any object, moveable or stationary. The insert in FIG. 11 presents a front view of the present invention having an illuminated audience unit 200 with some or all of the elements of the audience unit of FIG. 11, as described in my U.S. Pat. No. 8,194,118, incorporated herein by reference, having one or more light emitting ele-ments 206 which may be referred to as light emitters or modulators, light modulator, light emitting/modulator ele-ments, LEDS, light emitter or light array, a connecting mem-ber 214, handle 212 and an active receiver 202 capable of receiving optical or acoustic signals. In operation, the show director at the control board 18 or instrument sends a sequence of commands, live or from a stored visual or audio program, over the performance system data network 14 to the projector/signal generator 100 which emits a precisely timed series of directional signals 106, 106″, 106″ programmed to activate the audience units 200 at a precise location impacted by the directional signal 106. In its simplest embodiment, the projector/signal generator 100 displays an invisible IR 106 image at a specific wavelength (880 nanometers, for example) on the audience 22 which causes the wavelength-specific audience unit communication receiver 202 to activate one or more light emitters or modulators 206. The projector/signal generator 100 may also transmit a program sequence for later execution and display. Each audience unit may contain a unique encoded identifier entered during manufacture; at the time of purchase or distribution; or transmitted by the projec-tion system to the audience at any time, including during the performance. The data protocol may included well-known communication protocols such as but not limited to IR RS-232, IRDA, Fiber Channel, Fiber Ethernet, etc. The pro-jector/signal generator 100, referred to hereafter principally as “projector 100”, may also project a visible light beam containing visual content as well as a data stream by modu-lating the frequency above the human visual system integra-tion frequency of 30 Hz. It may be understood that the pro-jector/signal generator 100 in its photonic form encompasses the simplest gobo projector as well as the most complex, integrated terahertz-modulated photonic signal generator and spatial light modulator.

The Light emitting elements 206 may refer to any type of photonic source such as but not limited to incandes-cent, fluorescent, neon, electroluminescent, chemical, LED, laser, or quantum dot; or to combinations of light modulating combinations such as but not limited to thin film LCDs, backlit or reflective, E*INK type reflective modulators, chemical, photonic or electronic chromatic modulators. A camera system 300 may be employed to monitor the audience and/or audience units and provide feedback for a number of manual or automated design, setup and operating procedures. The camera system may be incorporated into the projector/signal generator unit 100. If not property configured said data signals 106 may interfere and degrade the rate and integrity of transmission. In order to synchronize the data projectors 100, a time code signal may be transmitted from the system control board 18, a designated master controller 100. Each data projector 100 may be programmed with a calculated offset from the time-code signal based on its distance from ‘center of mass’ of the audience, the location of other controllers, exter-nal environment, and other factors. A central timecode bea-con 140 may transmit the time-code signal to each of the data projectors 100 by means including but not limited to photonic, acoustic, or RF signals.

A feedback system from the cameras 300 may be used to adjust the performance including but not limited to projecting a fine pattern and adjusting the intensity of the data signal 106 until the appropriate resolution is achieved. The audience unit may employ an IR or other non-visible emitter for adjustment, diagnostic and other purposes. Various user input devices including microphones, buttons, switches, motion detectors, gyroscopes, light detectors, cameras, GPS and other devices may be included 216.

Image Recognition Elements and Accessories

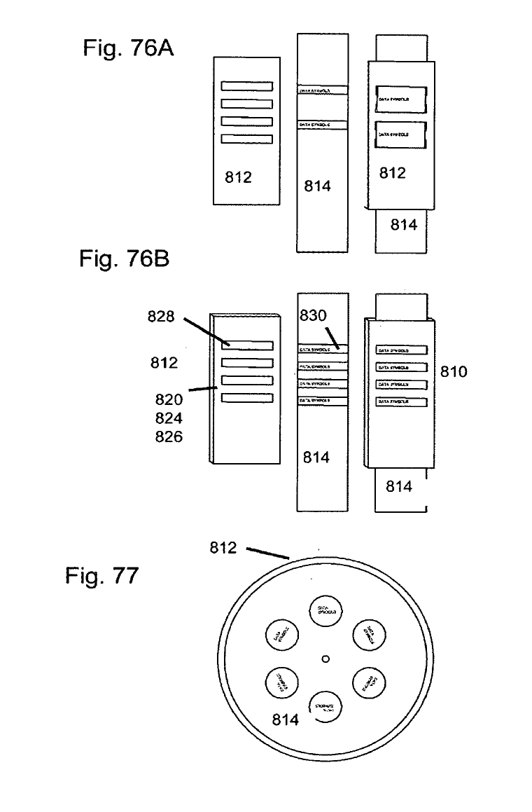

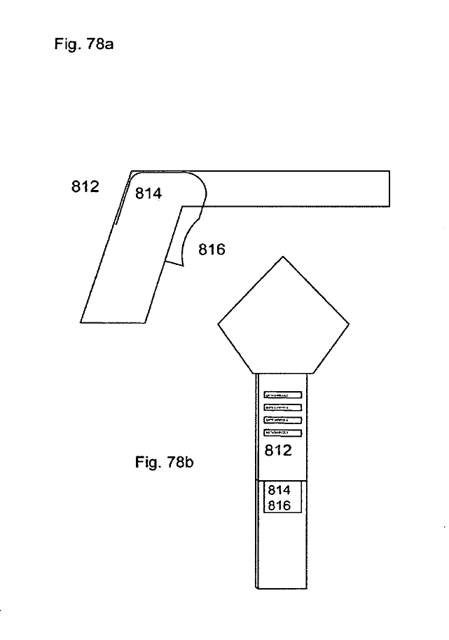

FIG. 76A presents a perspective view of a sleeve embodiment of an augmented reality, image target, marker or object 810 such as but not limited to that used by Vuforia™ software, having a first part 812 which may be affixed to an image target device 800 shown in FIG. 78. The image target first part 812 may have a defined contour element 820 in the form of a solid line and a contrasting margin, and a pattern of base definition elements 824 shown as but not limited to a simple embodiment of periodic, solid lines 826; and intervening transparent regions 828. The second, moving or dynamic part 814 is visible in the transparent regions 828 and may be comprised of one or more data elements 830,

In operation, the data elements 830 change upon activation, cue or instructions from the user, or internal or external programming. In a simple, practical embodiment the image target device 800 is a ‘magic wand’ 830, the image first part 812 is affixed to the handle 832, and the image target moving part 814 is affixed to a movable insert 834 which is activated by pressing or sliding a button or trigger 836. An alternative embodiment employs a display such as but not limited to a “smart phone screen OLED matrix” which may be activated by the user, external control, and/or sensors within the image user base 836. The sensors, not shown, may include motion, GPS, light, sound, proximity, temperature, moisture and other known sensors. A communication element (not shown) such as an RF, audio, electromagnetic wave, visible or IR receiver/transceiver may be included.

FIG. 76B present a slotted embodiment of the image target element where the first masking part 812 is a flat sheet with cut-out slots and the second moving data part 814 has the data spaced appropriately to display with moved relative to the cut-outs.

FIG. 77 presents a front view of an augmented reality, image target, marker or object 810 such as but not limited to that used by Vuforia™ software, having a first part 812 which circular and a second part 814 which rotates relative to the first part 812.

FIG. 78a presents a side view of representative gun embodiment wherein the second moving part 814 is displaced by the action of the trigger 816. Said gun may be constructed of paper, cardboard, plastic or other materials.

FIG. 78b presents a side view of magic wand/Saber handle embodiment wherein the second moving part 814 is displaced by the action of the button 816.

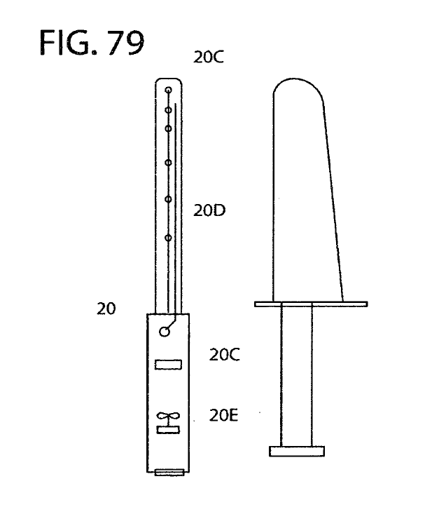

FIG. 79 presents general (b) and schematic side (a) views of a light saber 10 having a handle 12 and a blade 14. In the present invention, the blade 14 is an expandable material including a translucent, sealed, inflatable fabric 40 which is inflated by fan 18 and incorporates affixed in the interior one or more LEDs 30. Expansion and retraction may be provided by elastic/spring materials and/or an expansion/retraction spool 30. A computational sensor unit 20 may provided communications in real world or an augmented reality environment, positional, motion, ambient light, temperature, proximity, interactivity and other parameters. A soft layer of foam may be included to increase the safety of the light sabor blade. Power, smart phone, blue tooth, optical communications and other known components are not shown.

Beam Direction Projector Image—Data Elements of the Present Invention

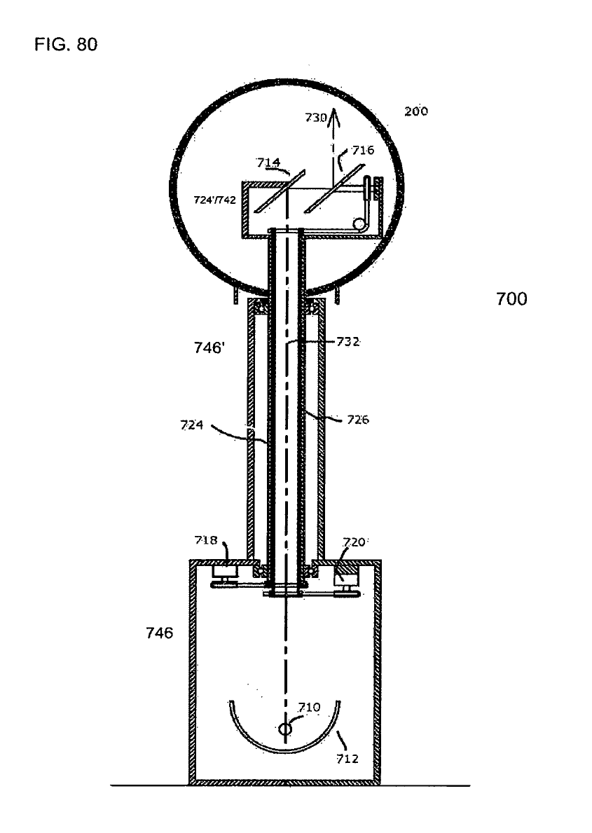

FIG. 80 presents a preferred embodiment of a beam directional system for the projector/signal generator/camera units 700 which does not require a slip ring, split transformer or other electronic power transfer to control the ‘tilt’ mirror. The generalized beam-direction system comprises a light/signal source 710 with reflector 712, a first ‘pan’ mirror 714, a second ‘tilt’ mirror 716, a first ‘pan’ motor 718 and a second ‘tilt’ motor 720. The pan motor 718 drives (shown with a belt drive) beam direction assembly or unit 722 by its rotatable pan tube 724. Rotatable in the interior of the pan tube 724 is the tilt tube 726 which is driven by tilt motor 720. Tilt mirror 716 is driven shown driven by a right angle, belt drive 728 from the top of the tilt tube 726 to the tilt mirror pulley. Gearing may also be employed. In the present two-mirror embodiment the optical axis 730 is offset from the center of rotation 732.

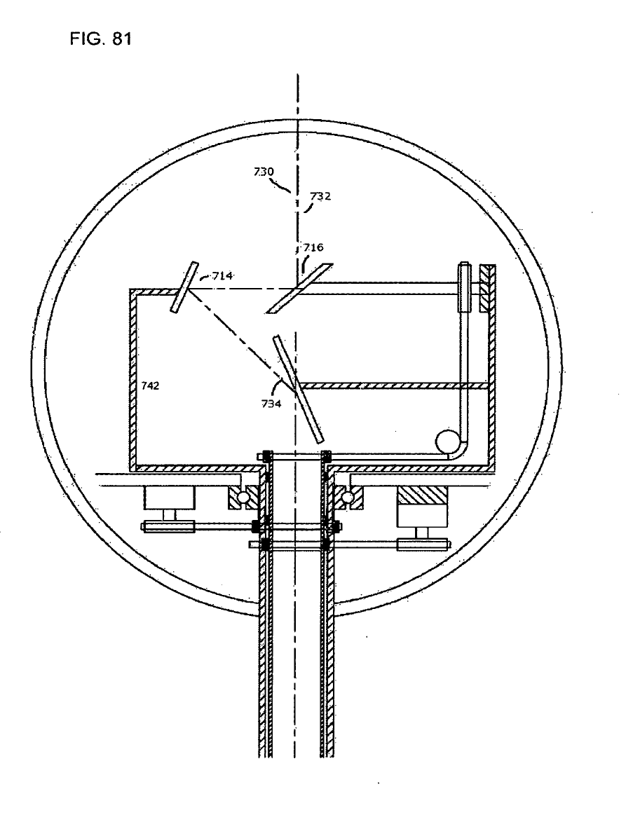

FIG. 81 shows a three-mirror embodiment with a centering mirror 734 which enabled the coaxial positioning of the optic 730 and rotational 732 axes.

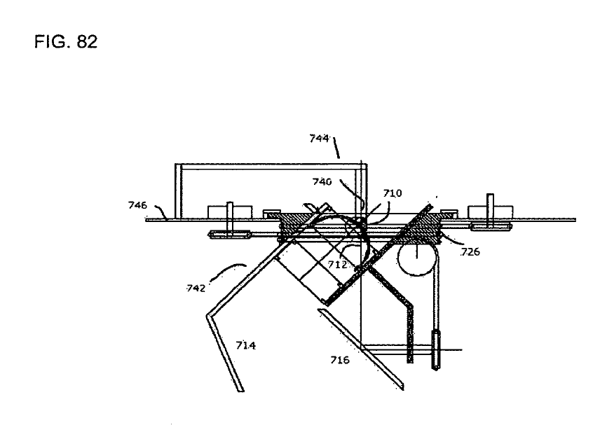

FIG. 82 shows an alternative embodiment with a pivotable light source and optics module 710, 712 pivotably mounted, shown on a ball and socket gimbal 760, but may include any articulated mounting or gimbal 750/752 such as but not limited to gyro-pivot, flexible polymer or magnetic, in the beam direction housing 742 and with an anti-rotation mechanism employing a stationary arm 744 affixed to the outer housing 746 and a pivotable, but non-rotational, ball joint 740. The source module 710/712 is free to assume any angular position relative to the arm. The tilt drive mechanism may be collapsed into a single external rotational tube. [0201] One advantage of the present embodiment is that a power-line affixed to the stationary arm 744 remains untwisted as a result of the non-rotation of the beam direction unit housing 710/712.

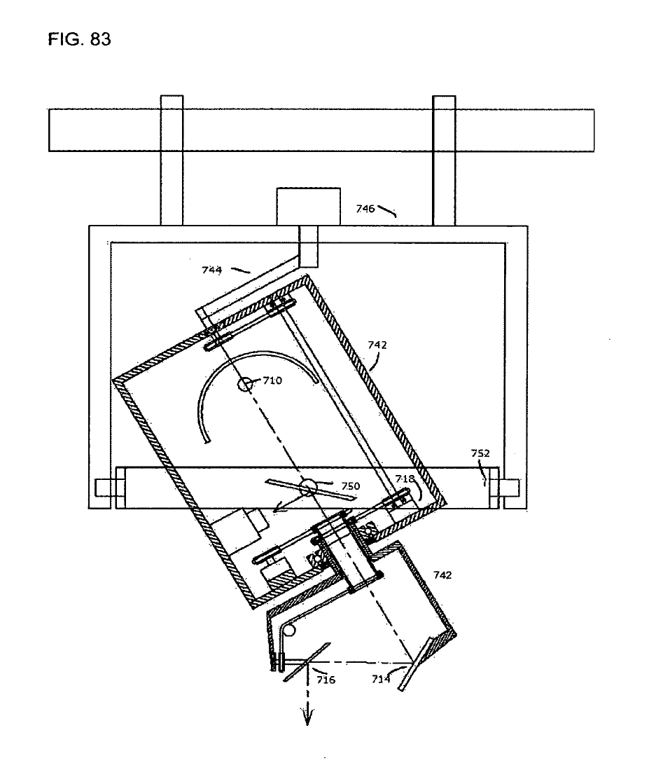

FIG. 83 shows an articulated, gyroscopic mount embodiment where the pan arm motor 718 rotatable attached at both ends forces the beam direction housing 742 to articulate about the central axis at a proscribed angle. The gyroscopic/gimbal mount 750, 752 maintains the orientation of the beam direction housing 742. The tilt mirror 16 is driven by the tilt motor 20 also mounted on the beam direction unit 22. The pan motor may be mounted externally on the rotational pivot arm 744. One advantage of the present embodiment is that a power-line affixed to the housing 742 remains untwisted as a result of the non-rotation of the beam direction housing 742/710/712. Another advantage is that a full and continuous 360 degree pan and tilt may be achieved with a reduced momentum.

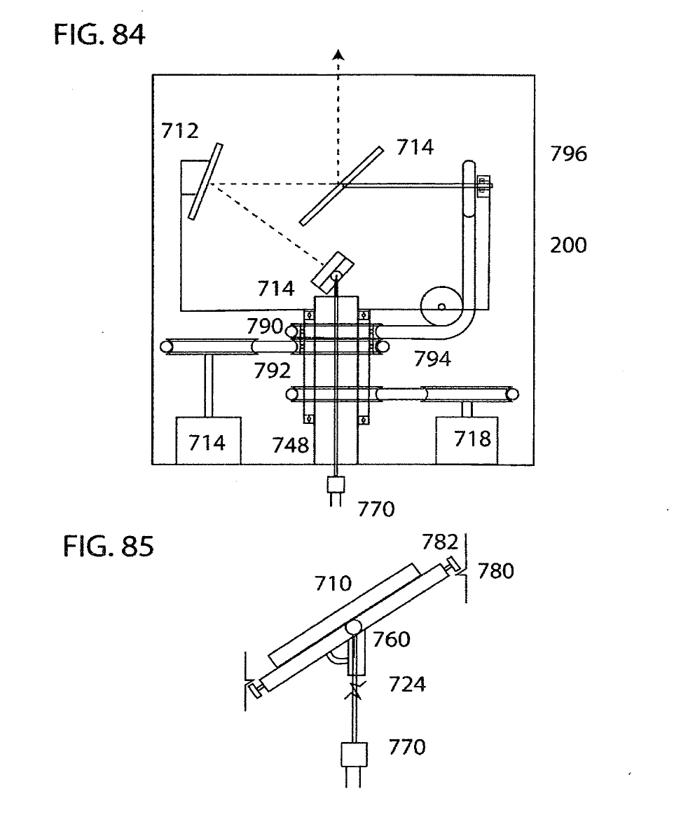

FIG. 84 shows an embodiment where the central stationary tube 748 supports the light source 710 (LEDs, including power and cooling, for example) and gimbal means 750/752 and the stationary power 770. The external pan/tilt mirror tube 724 is external to the stationary tube 748 and is driven by the pan motor means 718. The tilt drive mechanism 790 is dual-belt pulley in mounted on a bearing with the inner race 794 affixed to the pan/tilt support tube 724 and the outer race 792 affixed to the dual-belt pulley 790. The tilt drive means/motor 714 drives the dual-belt pulley 790 by a first belt which mechanically drives the tilt mirror by means by a second belt means 796.

FIG. 85 shows an embodiment to maintain the proper orientation of the light source 710 wherein an angled track 780 on the rotational pan tube 724 drives a light source platform wheel 782. The light source platform 710 is rotational fixed in the horizontal plane and thus the rotation of the pan tube 724 results in a vertical force applied by the track 780 on the wheel 782. A ball and socket pivot 760 which may be in alignment with the center of rotation is shown. The static power source 770 which may be integrated with or internal to the stationary tube 748 is shown exiting the side of the tube 748 and attached to the pivotable, but non-rotational platform 762.

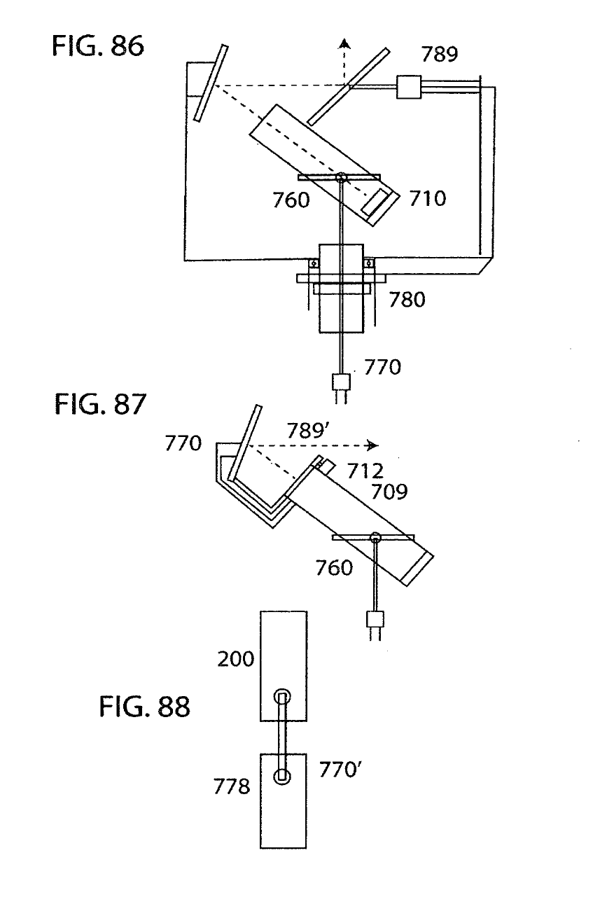

FIG. 86 shows an embodiment having a split transformer 788 or other means of electrical power transfer (including photonic) providing the electric power and signal to drive the tilt motor 789. A gimbal, two-axis yoke pivot 760′ which may be in alignment with the center of rotation is shown. The static power source 770 which may be integrated with or internal to the stationary tube 748 is shown exiting the open end of the tube 748 and attached to the pivotable, but non-rotational platform 762.

FIG. 87 shows an embodiment having electrical power transfer (including photonic) providing the electric power and signal to drive the tilt motor 789 on the gimbal light tube means with a rotational yoke 789′.

FIG. 88 shows an embodiment pivoting a base unit 770′ about a pivot 778 resulting in a compact package for transport and shipping.

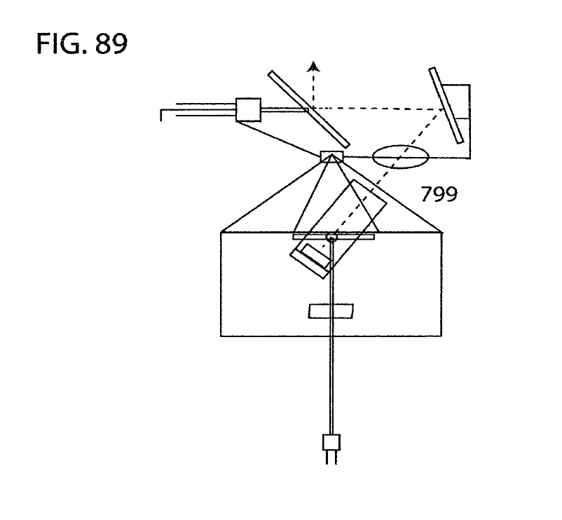

FIG. 89 shows an embodiment having a transparent support plate 799 including an embodiment where the transparent faces are orthogonal to the light source tube.

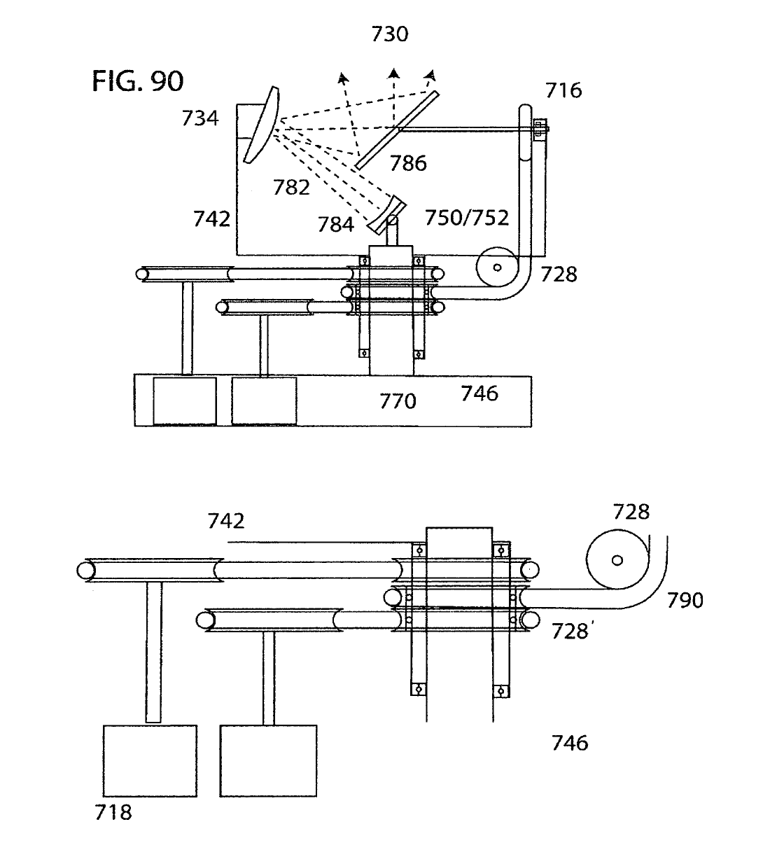

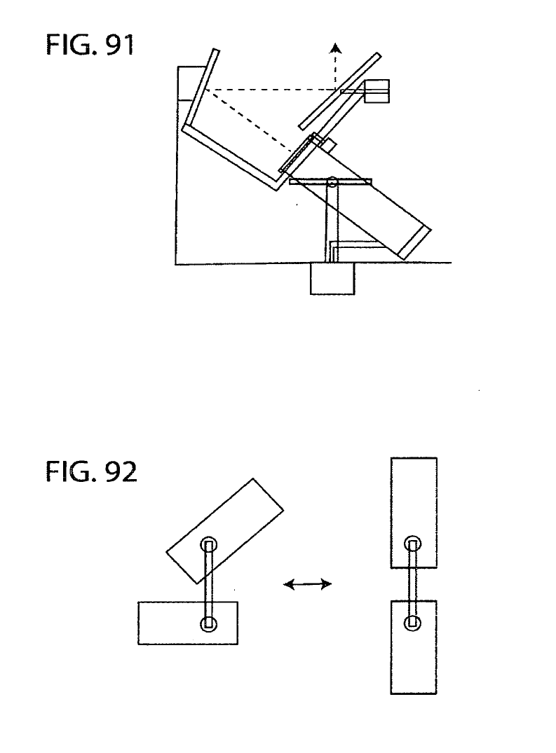

FIG. 90 shows a preferred embodiment where the central stationary tube 748 supports the light source 710 (LEDs, including power and cooling, for example) on a pivotable assembly 786, having a gimbal means 750/752 and the stationary power 770 connection. The external rotational, beam direction, tilt mirror assembly 742 is rotational to the stationary tube 748 and is driven by the pan motor means 718 shown in the insert as a belt drive with second pulley affixed to the rotational assembly 742. The tilt drive mechanism 790 is dual-belt pulley 728′ in mounted on a bearing with the inner race 794 affixed to the pan/tilt support tube 724 and the outer race 792 affixed to the dual-belt pulley 790. The tilt drive means/motor 714 drives the dual-belt pulley 790 by a first belt which mechanically drives the tilt mirror by means by a second belt means 796.

The gimbal motion force of the pivotable assembly 786 is provided by connecting pivot driver member/assembly 782 between the pivotable assembly 786 and a point on the Beam Direction Assembly 742. In a preferred operation, as the beam direction assembly 742 rotates, it applies a tensile force to pivotable assembly 786. In the accompanying FIG. 90, the driver member 782 is shown as a single element 782. Alternative constructions having a multiplicity of elements 782, 782′, 782″, arranged for example but not limited to the periphery of the pivotable assembly 782, may be employed. One side of each driver members 782 may be rotatable, shown as bearing 784, to either the beam directional assembly 742 or the pivotable assembly 786. In a simple embodiment as shown in FIG. 90, a connecting member 782 collocated with the principal optic axis 730 causes the pivotable assembly 786.

FIG. 93 presents a slidable, overlapping embodiment of the transformable headset/glasses wherein a central clasp is released allowing the respective lens to overlap each other and secure into opposing clasps at the arms.

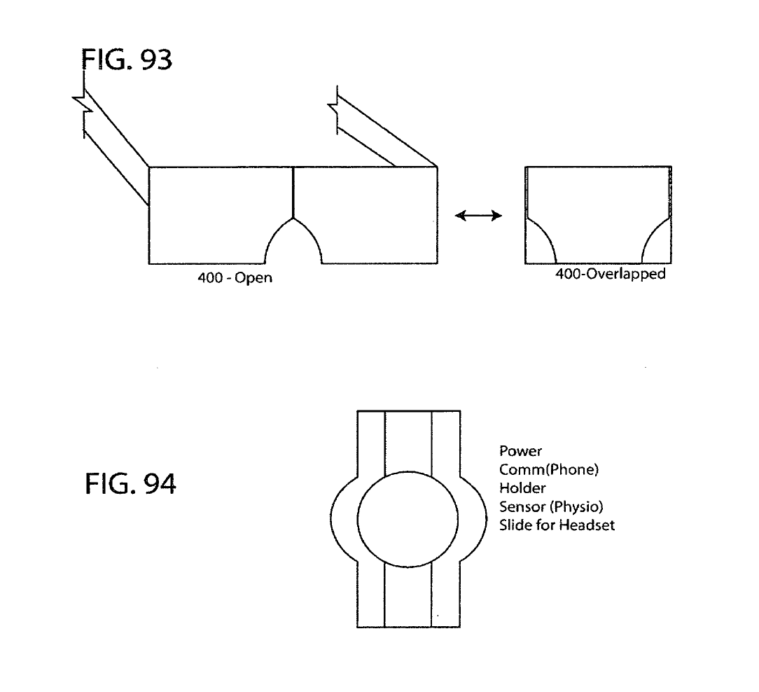

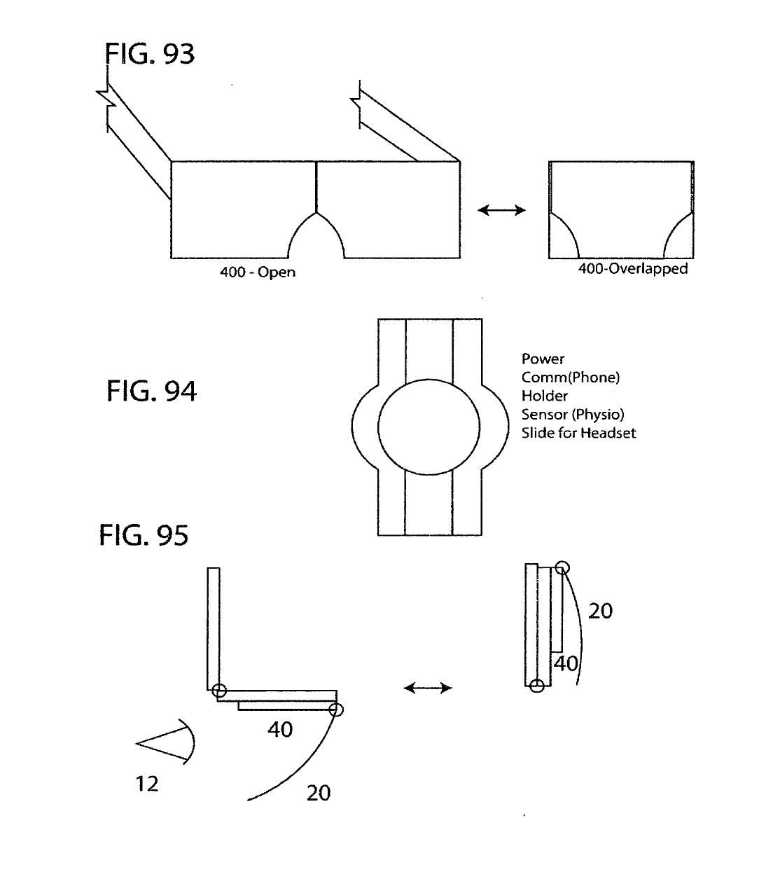

FIG. 94 shows a variant of FIG. 69.

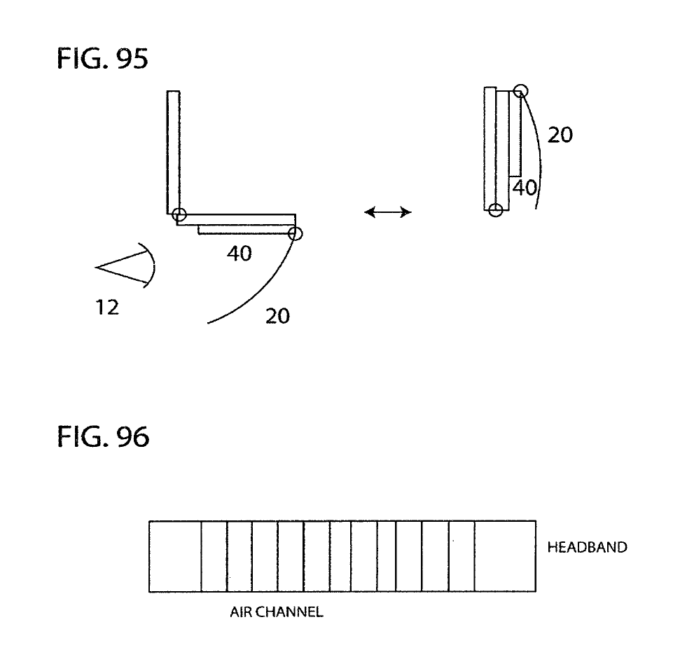

FIG. 95 shows a variant of FIG. 61.

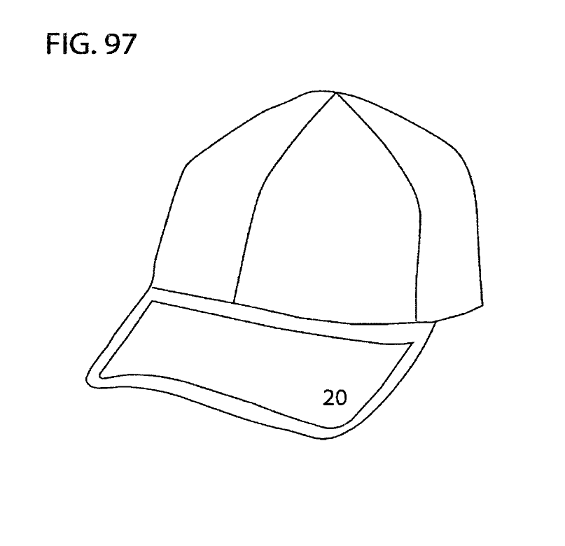

FIG. 96 shows a variant of FIG. 50.

FIG. 97 presents a flexible, reflector/visor which conforms to and folds underneath the curved brim shape of the popular baseball cap.

1. An integrated augmented and virtual reality system comprising:
an integrated headset comprising
a first partially-reflector surface means,
a first transmissive lens means,
a second reflector means, and
a first display screen means.

2. An augmented and virtual reality system in accordance with claim 1, further comprising a complex, curved first reflector means,
a optional transmissive optical means,
a second, complementary, complex, curved reflector means,
enabling the display of said display screen means to a user as a proscribed virtual distance.

3. An augmented and virtual reality system in accordance with claim 1, further comprising foldable side panels.

4. An augmented and virtual reality system in accordance with claim 1, further comprising at least one of the following:
a computational means,
a positional sensor means,
an environmental sensor means,
a user monitor means,
a full occlusion, virtual reality shield or cover,
an external camera means and
an external camera FOV displacement means.

5. An augmented and virtual reality system in accordance with claim 1, further comprising an individual headset and/or accessories having a data receiver means enabling the receipt of a data set from a projector means, and a means to respond to said data set with the designated commands or operations.

6. An entertainment system comprising:
a data/image projector means having a gimbal light/data source element enabling 360-degree rotation following a single-axis rotating frame, said frame comprising a first reflector means and second, rotational reflector means.

7. An augmented and virtual reality system further comprising a transformable wristwatch to headset.

8. An augmented and virtual reality system in accordance with claim 7. further comprising having a base wristband.

9. An augmented and virtual reality system in accordance with claim 7. further comprising an optical wavelength (UV-Visible IR) receiver and external display elements.
